(19) United States
(12) Patent Application Publication
(10) Pub. No.: US 2023/0316261 A1
(43) Pub. Date: Oct. 5, 2023

(54) Systems and Methods for Portable Identity, Documents, and Transactions

(71) Applicant: Akporefe Agbamu, Oakdale, MN (US)

(72) Inventor: Akporefe Agbamu, Oakdale, MN (US)

(21) Appl. No.: 18/119,281

(22) Filed: Mar. 9, 2023

Related U.S. Application Data
(60) Provisional application No. 63/317,804, filed on Mar. 8, 2022.

(51) Int. Cl. G06Q 20/36; G06Q 20/32; G06Q 20/40

(52) U.S. Cl. CPC G06Q 20/363; G06Q 20/3278; G06Q 20/3674; G06Q 20/40145

(57) ABSTRACT

A portable identity, document, transaction, data, and access management system for interoperable and reusable onboarding and client lifecycle management, includes an identity management system employing at least machine or deep learning for streamlining functionality comprising biometrics analysis, optical character recognition for analyzing documents, leveraging identification systems and databases for training and verifying, and a document management system facilitating at least electronic file transfer, digital and biometric signatures, enabling at least the editing, sending, receiving, sharing, transferring, storing, tracking of documents, and a transaction management system utilizing at least machine or deep learning for activities comprising detecting known and unknown typologies, mitigating false positives, enabling at least the executing, clearing, settlement, monitoring, screening, recording, and reporting of transactions.

### CROSS-REFERENCE

This application claims priority under 35 USC § 119 to U.S. Provisional Patent Application No. 63/317,804, filed on Mar. 8, 2022. The disclosure is included herein in its entirety at least by reference.

### FIELD OF THE SYSTEM

The system is in the field of portable, reusable, interoperable, and non-fungible identity, document, and transaction management systems for onboarding and client lifecycle management and processing systems.

### DISCUSSION OF THE STATE OF THE ART

In the art of onboarding and client lifecycle management, more particularly, by businesses and governments—the onboarding and client lifecycle process can be broken into four components—identity management (verifying the identity of an individual or business), document management (exchanging and signing agreements, terms, documents), transaction management (monitoring, screening, and reporting), data management (centralized, decentralized).

The collection of identity, document, and transaction data for onboarding and client lifecycle management is repetitive and requires the duplication of sensitive information at each onboarding entity, despite much of the core information is the same. Verifying the identity of individuals and businesses is highly fragmented, siloed, and centralized. Centralization limits the ability for data to be ported, interoperable, and reusable amongst other onboarding entities. This lack of systems that reuse and recycle onboarding and client lifecycle heightens the risk of data being compromised. As data collected during onboarding and throughout the client lifecycle is centrally stored at each organization or institution collecting it.

Another limitation is the inability to ensure the integrity, immutability, and security of information being transferred, in the event centralized systems are compromised, as is often the case. Centralized and decentralized regulated and/or unregulated organizations, entities, and protocols that offer goods and services that require the collection and processing of identity, document, and transaction information prior to providing or renewing goods and services, are essential to everyday life. Leaving users with little to no alternatives than to subject their data to inevitable data breach, in addition to providing little to no control over their personal information once captured.

Therefore, what is clearly needed in the art is a portable, reusable, interoperable, non-fungible identity, document, and transaction management systems onboarding and client lifecycle management. Such a system is disclosed and claimed herein

### SUMMARY OF THE SYSTEM

In one embodiment of the invention a portable identity, document, transaction, data, and access management system for interoperable and reusable onboarding and client lifecycle management is provided, comprising an identity management system employing at least machine or deep learning for streamlining functionality comprising biometrics analysis, optical character recognition for analyzing documents, leveraging identification systems and databases for training and verifying, a document management system facilitating at least electronic file transfer, digital and biometric signatures, enabling at least the editing, sending, receiving, sharing, transferring, storing, tracking of documents, a transaction management system utilizing at least machine or deep learning for activities comprising detecting known and unknown typologies, mitigating false positives, enabling at least the executing, clearing, settlement, monitoring, screening, recording, and reporting of transactions, a communication system enabling at least two devices to have encrypted communication, facilitating secure transmission of identity, document, transactions, an account management and monitoring system enabling at least algorithmic, machine and/or deep learning, logic, rules-based access, alerts, notifications, at least one non-fungible smart contract or decentralized identifier for facilitating actions comprising synching, verifying, accessing, signing, sharing, downloading, executing, of identities, documents, transactions, a wallet systems for facilitating, authorizing, accessing, sorting, transferring, and tracking identities, documents, transactions, assets, and a data storage system for storing, sharing, accessing, retrieving, updating, and synchronizing identity, document, and transaction information in centralized and/or decentralized capacities, data is routed, stored, querying centralized and decentralized storage systems via at least a unique identifier.

Also in one embodiment, the communication system is utilizing video and/or messaging chat for at least two people to communicate and facilitate onboarding and client lifecycle management. Also in one embodiment, the communication system utilizes near-frequency communication for the contactless transmission of identities, documents, and transactions. Also in one embodiment, the wallet system is synchronized with at least one non-fungible smart contract or decentralized identifier. Also in one embodiment, the wallet system supports fiat, digital, and blockchain assets. Also in one embodiment, the wallet system may be linked to at least one NFC embeddable and compatible virtual, digital, portable, and/or physical device.

In another aspect of the invention, a computer-implemented method for portable and reusable onboarding and client lifecycle management is provided, comprising authenticating, the identity of at least one individual and/or business, employing varying methods for ascertaining, qualifying, verifying identity, prior to fulfilling data requests between at least two systems, devices, applications, and/or networks, requesting, receiving, sending, signing nonces between systems, devices, applications, and/or networks, validating, unlocking credentials for accessing identity, document, and/or transactions synchronized to at least one individual and/or business, querying, decentralized and/or centralized data storage systems, utilizing at least one unique identifier for identifying identity, document, and/or transactions, retrieving, identity, document, and/or transaction data based on known or unknown onboarding criteria and requirements, and transmitting, identity, document, and/or transaction data from centralized and/or decentralized storage, utilizing methods comprising API, webhook, QR code, and NFC, enabling recycling and porting of identity, document, transaction for onboarding and client lifecycle management.

In one embodiment of the method, the decentralized storage siloes data of at least one individual and/or business into at least one data bucket. Also in one embodiment, the decentralized storage is synchronized with at least one non-fungible token or decentralized identifier. Also in one embodiment, the decentralized siloed storage is synchronized with at least one non-fungible token or decentralized identifier.

### BRIEF DESCRIPTION OF THE DRAWING FIGURES

Illustrative, non-limiting exemplary embodiments may be more clearly understood from the following detailed description, particularly when taken in conjunction with the accompanying drawings, in which:

FIG. 1 is a data flow diagram illustrating an identity management system according to certain exemplary embodiments of the system.

FIG. 2 is a flow process depicting a facial recognition pipeline according to certain exemplary embodiments of the system.

FIG. 3 is a data flow diagram depicting an identity management system according to certain exemplary embodiments of the system.

FIG. 4 is a flow process depicting the depicting passwordless authentication process according to certain exemplary embodiments of the system.

FIG. 5 is a data flow diagram depicting passwordless authentication systems according to certain exemplary embodiments of the system.

FIG. 6 is a data flow diagram illustrating document management systems according to certain exemplary embodiments of the system.

FIG. 7 is a data flow diagram illustrating identity and document management systems according to certain exemplary embodiment of the system.

FIG. 8 is a process flow chart depicting identity and document systems according to certain embodiments of the system.

FIG. 9 is a flow process depicting identity, document, and transaction systems according to certain exemplary embodiments of the system.

### DETAILED DESCRIPTION

The inventor provides portable, reusable, and interoperable, identity, document, transaction, and data management systems for compliant onboarding and client lifecycle management. Said onboarding and client lifecycle management systems may utilize non-fungible and fungible smart (programmable) contracts, decentralized data oracles, decentralized autonomous organizations, and decentralized data storage for distributed and Sybil-resistant identity, document, and transaction management. Enabling centralized and/or decentralized regulated and/or unregulated organizations, entities, DApps, systems, and protocols, across industries and applications, to reuse and port onboarding and client lifecycle data and metadata. Certain exemplary embodiments may allow users to manage access and privileges to personal data using methods and systems—individual or in combination, comprising OTP, SMTP, push notification, biometrics, QR code, NFC technology, digital/virtual/blockchain wallets, and private keys, for controlling access and permissions to data that may be stored in at least one decentralized manner i.e., distributed ledger/blockchains, oracles, and decentralized storage. Certain exemplary embodiments of the disclosure may enable the reusability and portability of personal, business, and government identity, document, transaction (meta) data, and variable credentials. Thus reducing the data entities need to hold directly to conduct compliant onboarding and client lifecycle management, while simultaneously mitigating the risk of sensitive data being compromised and/or lost while storing and processing centrally.

The following descriptions of certain exemplary embodiments of the disclosed system are not intended to limit the system to these certain exemplary embodiments but rather to enable any person skilled in the art to make and use the system. The system is described in detail in the following examples, which may represent more than one exemplary embodiment of the system.

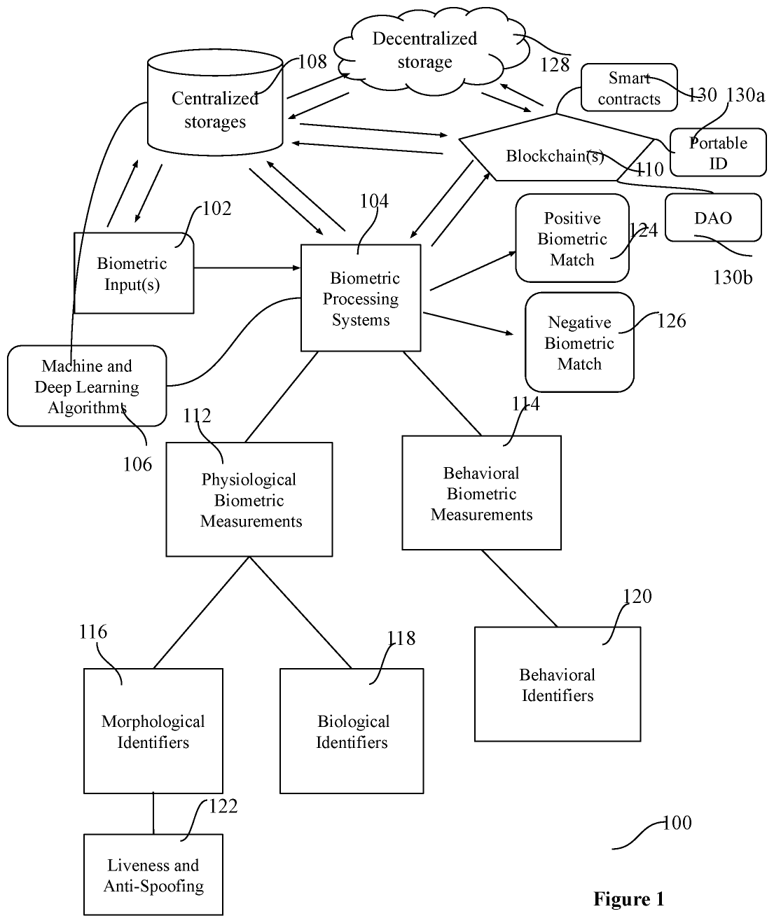

Referring to FIG. 1 is a data flow diagram illustrating an identity management system 100 according to certain exemplary embodiments of the system. In these certain exemplary embodiments, a biometrics system 104 utilizing at least machine/deep learning 106, may incorporate at least one layer and parameter for learning. Said biometrics system(s) 104 may be pre-trained (machine learning) and/or self-learning (deep learning) 106, acquiring insight over intervals, or continuously. The biometric capabilities 104 of the identity system 100 may utilize morphological identifiers 116 comprising a face 102, which may enable vector representations to be compared for facial verification 124-126 purposes. In certain exemplary embodiments, the Euclidean distance between two vectors may be utilized for n-dimensional vectors to find facial similarities, while false positives may be mitigated via optimization of factors comprising the threshold function, F1 score, precession, and recall.

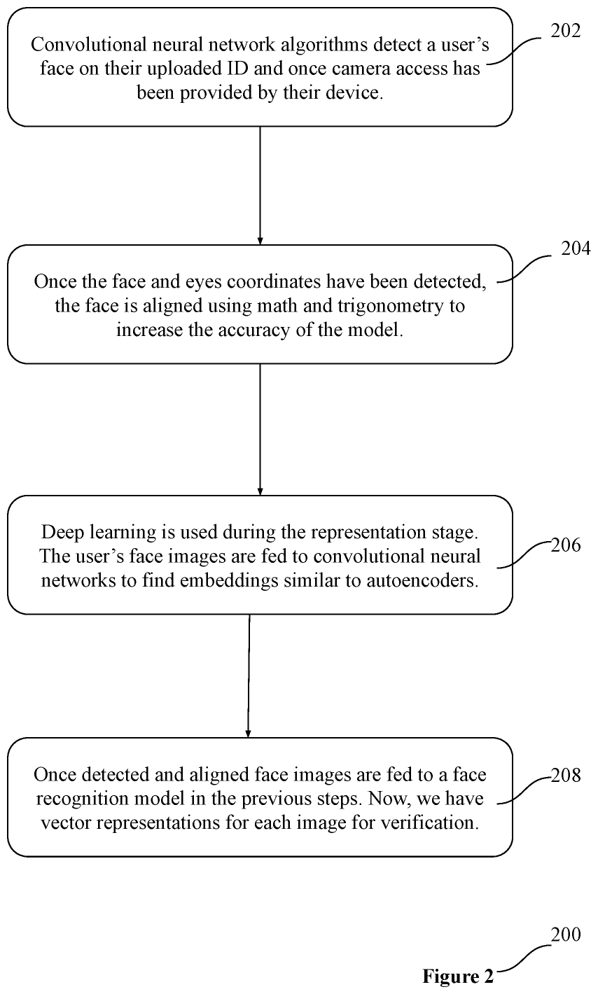

Referring to FIG. 2 is a flow process depicting a facial recognition pipeline according to certain exemplary embodiments of the identity management system 200 that may progress via detection 202, alignment 204, representation 206, and verification 208 phases. Certain exemplary embodiments of the disclosure may leverage algorithms of supervised and/or unsupervised intelligence 106, including but not limited to, convolutional neural networks and autoencoders to process images and videos 102. Algorithms utilized by the systems 104 for detection 202 may comprise haar cascade, single shot multibox detector, histogram of oriented gradients, max-margin object detection, and multitask cascaded convolutional networks.

Certain exemplary embodiments of the system may contain detection 202 and alignment 204 algorithms for face and eye detection and alignment, enabling the facial recognition 112 capabilities of the biometric system 104 of the system to transition to a representation phase 206 where face images 102 may be consumed and processed by convolutional neural networks 106 or other forms of intelligence for verification 208. Deep/machine learning models 106 of the identity management system 100 may be supportive of different input shapes and types 102, ayielding vector representations 208 per image. In certain exemplary embodiments, 1D vectors may be transformed into 2D matrices by appending said vectors, which may ensure that each line of the matrix contains similar attributes and variables, reaching a determination on whether two (or more) images may be the same person 124, based on said vector representations 208 relative to facial depictions 102.

In certain exemplary embodiments of the system, liveness and anti-spoofing 122 techniques and methods may be leveraged, spurring the biometric systems 104 to dynamically and accurately ascertain facial similarity 124-126. Additional benefits of exemplary embodiments of the disclosure may be liveness/anti-spoofing methods 122, singularly or in combination, user prompts and indicators for facial expressions (smiling, laughing, crying, blinking), audible responses (alphabet, 1-10, full name), hold something (written text, QR code, ID) to protect the integrity of facial biometric output 124-126 of the identity management system 100.

Certain exemplary embodiments of the system may accept biometric input 102 rendered as images, or video recordings that may be subsequently broken into images or frames, and consumed by computer vision and convolutional neural networks of a machine/deep intelligence 106. In certain exemplary embodiments, an object storage database may be used as a queue that stores images and videos prior to being processed. The optical capabilities of the disclosure may be used to authenticate and validate liveness, age, gender, and ethnicity, to determine whether a user is of the stated or implied age, gender, or ethnicity—helping to increase the efficacy and/or confidence of output 124-126 derived by the system.

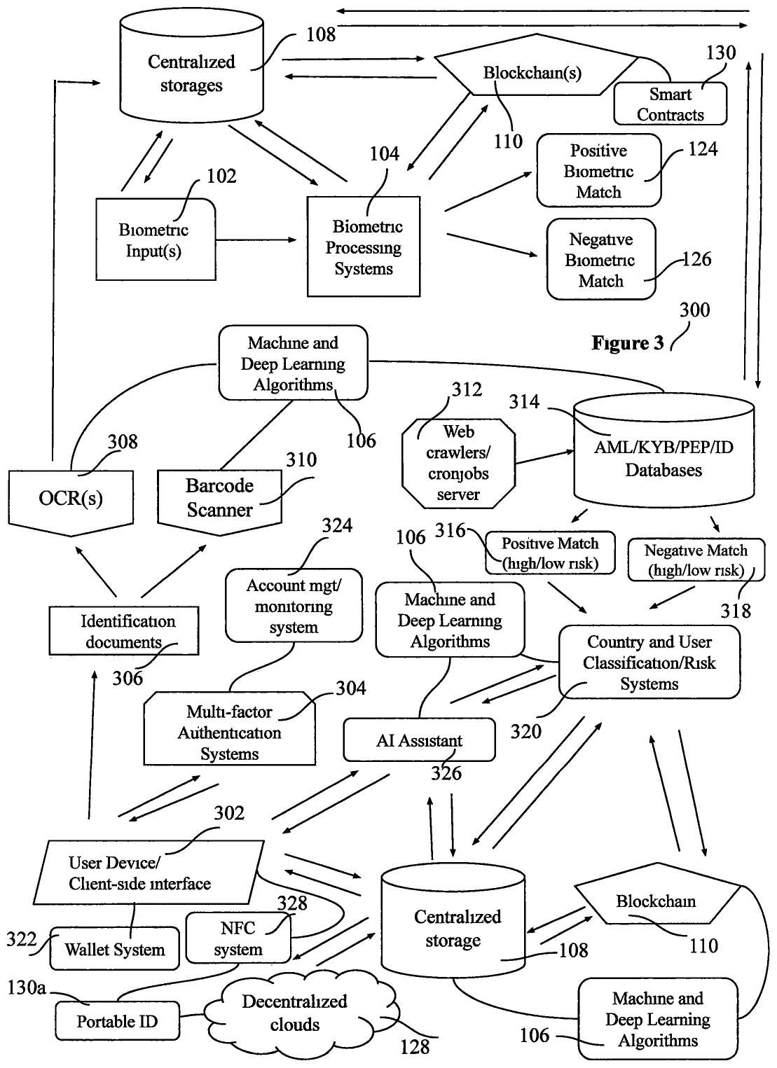

Referring to FIG. 3, the ID types 306 the system may detect and extract 308-310 images and data from include passports, national IDs, identity cards, driver's licenses, residential permits, and visas, among others. Certain exemplary embodiments of the identity system 10—may compare at least two images—real-time image 102 and image extracted from ID 306, to determine if there is a ‘match’124. The ‘match’124 threshold of the identity system 100 may be set and/or adjusted, without limitation, to provide optimal results. The closer the distance between the real-time image 102 and the image extracted from ID 306 is, the more likely a ‘match’ 124.

In certain exemplary embodiments, APIs may be used for communicating between client-side user interfaces 302 (SDKs, mobile, desktop, etc) recording and retrieving the biometric 102/124/126 information, and the server-side systems processing 104 and storing the data 108-110/128. 102. Results of biometric analysis 124-126 may be communicated via API calls to seed the database(s) 108 and the client-side application 302 and to 3rd party systems that utilize and/or store data. An advantage of certain embodiments of the system is the modularity and interoperability, wherein a 3rd party identity system may be leveraged by the system.

In certain exemplary embodiments of the disclosure, internal and/or external database(s) 314 utilized by the system may identify and classify IDs 306 by variables comprising country name, state name, ID type, ID name, security features, valid or invalid, and ID version type. This may enable the identity system 300 to determine the authenticity of documents 306 being uploaded, and compare the biometrics 102 of a user to the image 102 on an identification card 306 for verification 124-126. Certain exemplary embodiments of the system may provide a score(s) or ratings 320 to express whether a document is authentic 316 or inauthentic 318. APIs may be used for transmitting messages between client-side interface(s) 302 uploading the identity card 306 and the server-side systems 106 processing the retrieved. Responses 316-318 of identity document 306 analysis may also be communicated via API to centralized 108 and/or decentralized 110/128 storage, displaying results in the client-side application 302.

Certain exemplary embodiments of the system 300 that may utilize optical character recognition (OCR) 308, enhanced via intelligence of supervised and/or unsupervised methods 106, to aid in detecting and identifying regions of interest on documents 306. Enabling the extracting and synthesizing of uploaded documents for authentication, validation, verification, attestation, and classification purposes of the system 300. As an example, a user may take a picture, video record, screenshots, or scan an ID 306 via the client-side application 302 to capture the front, and optionally, the back of identification cards 306 for analysis. Information extracted via OCR 308 and/or barcode 310, QR, and NFC readers 328 from identification cards 306 may be compared to previously transmitted or forthcoming data 102 for authentication, verification, and validation. The user may upload additional documents—i.e., utility bills, bank statements, company filings, and tax returns for capture to positively further authenticate 124/316.

In certain exemplary embodiments of the system, regressions 106 may be used to spatially separate bounding boxes and associated class probabilities. Neural networks 106 may predict bounding boxes and class probabilities from ID 306 images 102 in single or multiple evaluations. In certain exemplary embodiments of the system, images may be processed 104 in real-time, continuously, or in intervals once uploaded. The system may use multiple cores to scale processing 104 biometrics 124-126 and identity 316-318 results. The identity system 300 may use object detection models 106 for the classification of different categories of identification documents 306. Models 106 may detect the identity document 306 and pass the cropped document or region or interest 306 for processing 308-310. The ID image 306 may be rotated clockwise or counterclockwise to an angle of ‘0’ degrees. A function may unshear the image using different logical functions and mathematical formulas, providing a cropped image of document 306.

Certain exemplary embodiments of the system 300 may use detection models 106 that may be trained or pretrained to detect the MRZ or barcodes from documents 306. Thereafter the MRZ may be cropped and sent to another model 106 for further processing. To improve the algorithm's 106 detection accuracy of the MRZ 306 text, the background may be removed from image 306, utilizing different filters and techniques to enhance the image 306 texts. The MRZ text from the document 306 image may be extracted, processed, parsed, and interpreted. ID 306 information comprising first and last name, ID number, date of birth, expiration date, and MRZ, may be extracted from identity document 306 by identifying regions of interest. Neural network 106 with at least one layer may be used for a single object and image detection and classification, and multiple objects and image detection classifications. The document OCRs 308 of the system may be multilingual, spurring usage across different countries and territories identification documents 306. In addition, the system may support various output formats comprising plain text, hOCR (HTML), PDF, invisible-text-only PDF, json, and TSV.

In certain exemplary embodiments of the system, barcode(s) at the back of the identification documents 306 may also be captured, uploaded, scanned, observed, and interpreted by the barcode scanner(s) 310 utilized by the identity management system 300 to extract information and authenticate 316-318 it against AML, KYB, PEP, and ID databases 314. Machine-readable technology 308-310 supporting two-dimensional barcode symbology may be present. Barcode recognition and interpretation systems 310 may be utilized for decoding various barcode types, including but not limited to PDF417 symbology, before subsequently parsing the barcode into human-readable formats.

Data extracted from identity documents 306 may be used to auto-populate forms and contracts via API to limit human error associated with manual data entry. Furthermore, information extracted may be transmitted and stored in centralized storage 108, CRMs, or decentralized storage 128. Extracted information and document verification results may be stored within the databases 108 (SQL/NoSQL) of the system and visualized via the client-side application(s) 302 of the system. All data within the system is encrypted at rest and in transit for optimal security.

In certain exemplary embodiments of the system, to ensure the authenticity of identification documents 302 submitted during onboarding, and throughout the client's lifecycle, the system having been trained, or utilize systems that have been trained via methods of a machine/deep intelligence 106 may analyze security features, watermarks, holograms, infrared, and UV features unique to each identification type 306 to ensure the quality and validity 316-318 of identification documents 306 referenced during onboarding and future authentications. Certain embodiments of the system may use tools comprising NFC passport readers to verify the RFID chip embedded in electronic passports, national identity cards, and other International Civil Aviation Organization (ICAO) compliant identity documents. Other security checks, comprising Active Authentication, Chip Authentication, and Passive Authentication may also be analyzed and validated.

In certain exemplary embodiments of the system, information extracted or manually entered during the onboarding and lifecycle process may be stored in decentralized 128 and/or centralized methods 108 by the system and fetched or transmitted via API, to be queried against AML and background check database(s) 314. Background databases may utilize distributed to store information, indexing information by data type or category, and add similar values at the beginning of indexes to search indexes simultaneously. Databases 314 comprising international and domestic (US) sanction list and blacklist, politically exposed persons, criminal background, eviction background, personal/business credit, adverse media, and sexual offenders databases may be queried.

Expanding on certain exemplary embodiments, web scraping 312 and other programmable means of data aggregation may be used to effectively aggregate and parse data from AML list, sanction list, blacklist, adverse media, and politically exposed persons (PEP), to be stored by the system's database(s) and utilized by the system via API. The system may run continuously, or leverage cronjobs 312 to automate the intervals in which data is collected 312 and stored 314. A benefit certain exemplary embodiments of the system is a system that may scrap/crawl 312 data in real-time, continuously updating the system's database(s) 314, utilizing hashing algorithms—i.e., MD5 and SHA-256, to create a hash of data stored to avoid duplicates, among other things.

Certain exemplary embodiments of the system is a system that classifies 320 and categorizes users based on the information during the onboarding process. Classification 320 categories may be determined by a plurality of variables comprising country risk, user risk, credit risk, payment status, investment tolerance, and business type. The various classifications 320 and categories types may be expanded or reduced at any time, without limitation. The system may give multiple classifications 320, or have classifications within classifications (subclassifications), without limitation. Classification types 320 and data used to derive them may also be retrieved via 3rd party APIs and databases, and/or by processing information captured by the system.

For example, users successfully onboarded may be classified 320 by the system as being simplified, standard, and enhanced due diligence cases. Users classified as ‘simplified’ may be of little risk, while those classified as ‘standard’ of neutral risk, while ‘enhanced’ users may be of high risk. Classification 320 utilized by the system may be contingent on the user of the system—i.e., a landlord may classify users by credit risk and rent paid status; a DMV may classify users by location (proximity to DMV) risk and driving (record) risk; an insurance company may classify users by health risks; a social media company may classify user risk by platform consumption and usage; while decentralized trading or lending platforms may classify users based on on-chain 110, off-chain 108 financial data, and user location.

Depending on the classification 320, certain exemplary embodiments of the system may determine that a user being onboarded is safe to use/access the entities services, utilize the services/access in a limited capacity, provide additional information to get a better understanding of the risk(s) 320 profile or prevent/restrict the user's access completely. Machine/deep learning algorithms 106 may be used to provide data-driven scores 320, optionally providing classifications 320 expressed in quintiles, deciles, etc.

Utilizing supervised/unsupervised deep learning algorithms 106, the system may develop and acquire knowledge (real-time, hourly, daily, weekly) to optimize participant results and risk assessment capabilities of the system, accordingly. Various inputs, including but not limited to IP location, device classification, country location, country risk score, and credit score may be utilized. The classification 320 of variables considered and derived by the systems of the system may be single and/or multi-factor variables. An advantage of certain embodiments of the system, is a system that may employ algorithms 106 to optimize classifications 320 via dynamic layers, characteristics, and variables of a specific user relative to a group of similar users based on a likely or unlikely set of variables.

Certain exemplary embodiments of the system may utilize learned systems 106 to identify, collate, bundle, or otherwise package 320 a universe of countries, sectors, industries, territories, and individuals based on factor outcomes of ranked countries, territories, and individuals. Thereby providing a system utilizing machine/deep intelligence 106, sorting, or ranking as a process or system based on said classification 320 and ranking for the effective and beneficial variables. These attributes may be selected or derived from an unlikely or likely set of variables, wherein attributes may suitably become the key determinants of classifications and segmentations. The management or finessing of these attributes, optimizing the appropriate attribute under set circumstances, provides the ability to rank individuals, businesses, and countries within a universe of individuals, businesses, and countries without limitation.

In another example of certain embodiments of the system, single or multiple fingerprints 102 may be utilized in the commission of biometric authentication 124-126 processes for onboarding. Attributes, characteristics, and qualities of fingerprint 102 may appear as a series of dark lines that may represent the high, peaking portion of the friction ridge skin, while the valley between ridges may appear as white space and the low, shallow portion of the friction ridge skin. Fingerprint 102 identification may be based primarily on the minutiae, or the location and direction of the ridge endings and bifurcations along a ridge path. An advantage of certain embodiments of the system—is optical sensors or the user's device 302 may be used to take an image of the fingerprint. The system may utilize a variety of sensor types—optical, capacitive, ultrasound, and thermal, for collecting the digital representation of a fingerprint surface. Matching techniques comprising minutiae-based matching and pattern matching may be leveraged.

The system may compare a user's fingerprint 102 to a stored 108 fingerprint image or template to validate 124-126 a user's identity for access, authentication, and validation into devices, systems, applications, databases, and networks. Given their unique nature, fingerprint scans 102 are inherently distinct. In certain exemplary embodiments of the system, a client may capture multiple fingerprint templates and use a PIN or another form or combination of multifactor authentication 304. Biometric templates, images, and depictions collected 102 during onboarding may be encrypted and stored using centralized 108 or decentralized means of data storage 110/128. In addition, a hash containing unique details of the biometrics 102 may be stored on-chain 110 or off-chain 108. In certain exemplary embodiments of the system, biometrics images 102 and their derivatives may be stored locally on a user's device 302.

A benefit of certain embodiments of the system is that may use morphological 116 or biological 118 biometrics identifiers. Morphological 116 identifiers comprising face, fingerprints, finger/hand shape, eye (retina and iris), and vein pattern, may be used; or biological biometrics comprising DNA, blood, and saliva. Behavioral identifiers 114 may also be leveraged, including but not limited to keystroke dynamics and signature dynamics comprising speed of the pen/typing, and the pressure exerted inclination. Enabling users of the system to access accounts, devices, applications, databases, and servers in a variety of different use cases across a multitude of industries for internal or external usage.

In certain exemplary embodiments of the system, passwordless authentication 400 may be present, which may leverage biometrics 102 (facial, fingerprint, voice, retina) to serve as attestation 508 to enable certain actions or functions within the system, or 3rd party devices, systems, applications, databases, or network. Biometric data 102 or hashes said data 102 that has been collected, extracted, may be requested, queried, and imported via a blockchain110, decentralized 128 and centralized systems 108, or locally on a user's device 302. Biometrics 102 aggregated may turn into a strong credentialing system, allowing authentication via multi-factor authentication (MFA) 304 comprising push notification, SMS, OTP, PIN, email, and use biometric 102 (fingerprint, face, voice), or a combination of biometric 102 and traditional MFA authentication 304 methods. This may present a more secure and unique method of authentication with the system and/or other systems using the authentication capabilities of the system, whether online or offline.

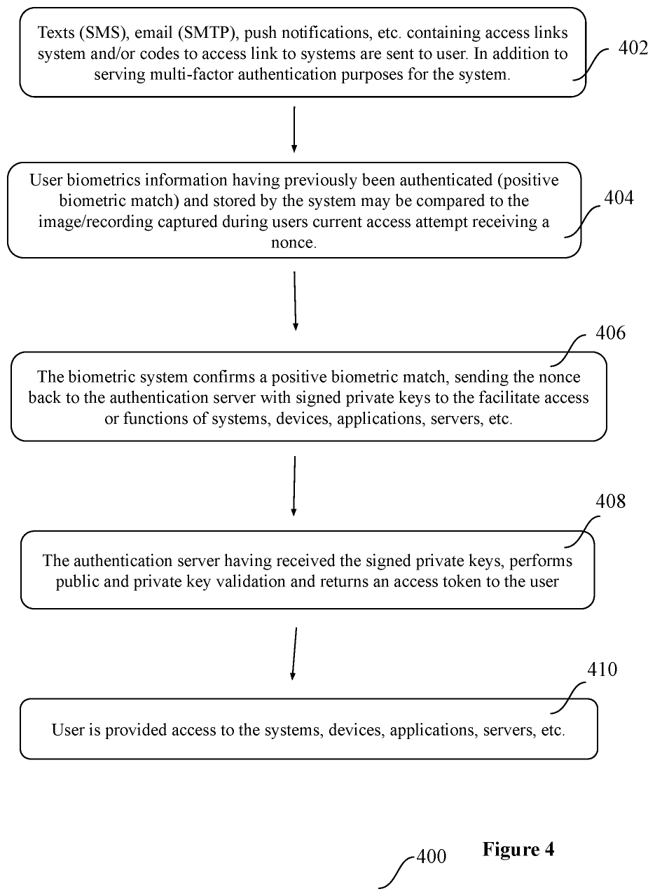

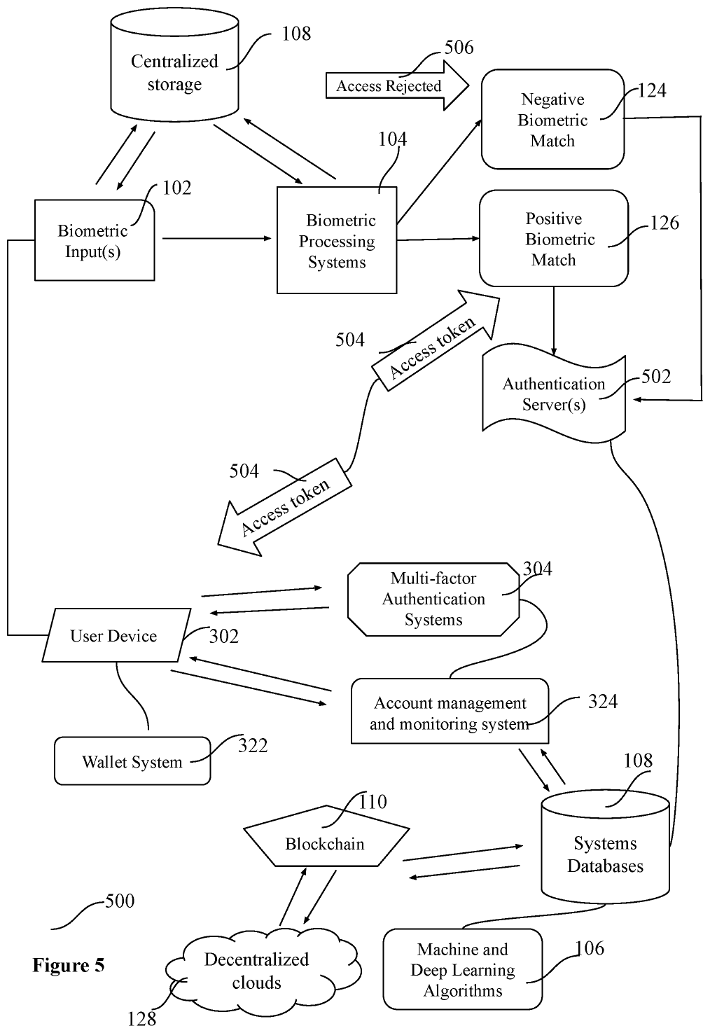

Referring to FIGS. 4 and 5 a process flow chart and data flow diagram, in certain embodiments of the system, the passwordless authentication systems 400 may authenticate via methods 304 comprising sending a link via email and/or SMS that enables users to authenticate upon clicking the link, or by entering a code (OTP) that was sent to the users' device 302. To start the process a user's device 302 may be prompted by the authentication server 502 at least one time to enter information (email, phone number). The requested information may be used to send a text message/email 304 to said user device 302.

For example in certain exemplary embodiments, a text message or email may be disseminated via SMS or SMTP, containing a code that may be used to access a link, or simply a link, to validate a device. In certain exemplary embodiments, upon the device 302 accessing said link via text or email an initial recording/capturing of the user's face may occur. Enabling the passwordless authentication system 400 to associate the user with the previously queried/shared information that serves as a source of truth for the authentication capabilities of the system 404.

To ensure that the facial authentication capabilities of certain exemplary embodiments of the system may be consistently robust, at predetermined or organic intervals, a user may be asked to reassess biometrics or upload a new government ID. Similarly to refreshing a traditional password, this may enable the identity management system to maintain an up-to-date credential. The identity system100 may learn 106 from facial biometric 102 and identification card 306 inputs that may be consumed in batches, intervals, or continuously.

To mitigate the risk and enhance the security of the systems, in certain exemplary embodiments, the system may utilize account management and monitoring systems 324. The said systems may aggregate data comprising device and browser classifications, IP location, ISP, latitude, longitude, and VPN detection to ensure authentication attempts occur from a device 302 and location that are trusted by capturing the IP of any system or device when an action is captured—i.e., clicking a button. Information may be cross-referenced 108-110, 314 against information 102/306 previously detected and gleaned by the systems. For example, if the system doesn't recognize or validate the device or IP attempting to make the request, or a private VPN is being used to log in for the first time when it typically is not, the attempt may be rejected. A push notification, email, SMS, or combination thereof, may be sent to the registered email or phone number of said user to validate authentication attempts and mitigate nefarious and fraudulent activities.

Securing user accounts from both bots and human attackers have become a fundamental challenge in delivering secure applications and services for governments and businesses that store sensitive information from onboarding and throughout the client lifecycle. Attackers continuously develop more sophisticated techniques for taking over valid accounts, creating fake accounts, and abusing trial signups, and loyalty programs. Constantly adapting to evade security controls. In certain exemplary embodiments of the system, advanced user behavior models and access patterns pinpoint complex threats that may allow the system's account management and monitoring system 324 to produce actionable insights. Insights may be gleaned over intervals or continuously. The account management and monitoring systems 324 may track pre- and-post-login activity and collect any pertinent events throughout any system or 3rd party systems, to better understand patterns. Thus helping to secure critical actions such as account login, profile changes, and various functionality tied to onboarding and client lifecycle management.

Certain exemplary embodiments of the system may leverage machine intelligence 106 of supervised or unsupervised nature for analyzing individuals and businesses across a broad spectrum of data points and events, including details about their devices, locations, access patterns, and cookies of the users device 302. The system may monitor each device based on the device type, operating system, browser, and user agent, among others. To provide enhanced predictability, users' behavior may be taken into account. This may include variables comprising access times, geographies of access, account age, and device classifications. It may extend to behavior within the application such as making changes to the account, time of performing certain higher-risk transactions, or virtually any other event in the application or system.

In certain exemplary embodiments of the system geolocations and IP addresses tied to users, device 302 may be used to determine the location of a user to begin the onboarding process and/or periodically thereafter, as may be determined by the system or admin of the system. A benefit of certain exemplary embodiments of the system is an MFA system 304 that may identify the country, region, city, latitude & longitude, ZIP code, time zone, connection speed, Internet Service Provider (ISP), domain name, IDD country code, area code, weather station data, mobile network codes (MNC), mobile country codes (MCC), mobile carrier, elevation, usage type, among other things. IP addresses including IPv4, and IPv6, may be compatible with the system. IP location information may be bundled, grouped, or coupled, with other data comprising identification documents 306 stored for verification 316-318 and validation purposes. Data/strings collected from each IP address validation, verification, authentication, and the attempt may be used independently or in combination with other data collected on the users for future classification and predictive purposes.

For example, if a user device 302 is being onboarded or logging into the system from a location in South Korea but has a US passport or driver's license, the system may inquire about the discrepancy. Registering and storing 108 the user's answers and using them as a determining factor of the system's identity verification and authentication processes. Expanding on the example, if the user were asked by the system via text, email, or virtual assistant 322, “have you traveled outside of the U.S. in the last 60 days?” A ‘no’ response would raise the user's risk score derived by the classification system 320 due to dishonesty (IP is in South Korea). Virtual assistant 322 may escalate the issue for human interactions or query for more information. In certain exemplary embodiments, authentication server(s) 502 may assess if the user exists in the database 108 and trigger onboarding via passwordless authentication flow 404. The device may receive a nonce from the authentication server(s) 502. Once the access is received 410, the user may complete the authentication flow 410, entering their biometric and/or PIN to unlock the private key. Once biometrics or other authentication mechanisms are confirmed 404-406, the nonce may then be signed with the private key and sent back to the system's authentication server(s) 502. The authentication servers 502 may perform public/private key validation and return an access token 512 and provide access or pass previously captured onboarding information via API, webhook, autofill, etc to 3rd party systems. By combining data encryption and tunneling protocols, all transmitted data, regardless of device or location, may be completely encrypted at rest and in transit. This level of security may ensure that only authorized connections may be established.

In certain exemplary embodiments of the system, a push notification may be sent by the authentication servers 502 to the devices to initiate onboarding or passwordless authentication via SDK/API, Apple Push Notification Service on iOS devices, Firebase Cloud Messaging on Android devices, or any push notification system tied to any desktop and mobile operating systems. For example, the user may receive the push notification 402. The application may call the system's authentication servers 502 and receive a nonce. Once the user completes the flow by entering their biometric and/or PIN to unlock the private key 404. The nonce is signed with the private key and sent back to the system authentication server 502. The authentication server 502 performs public/private key validation and returns an access token 512. The user device may now access the system, device, or application.

A benefit of certain embodiments of the system that may allow a user may contact support or customer service using any of the available mediums comprising the phone, message chat, or video chat from their device 302. The chat and video systems may be of the system or 3rd party. Enabling the real-time sharing of information and communication between stakeholders. The support agent may pull or query the centralized 108 or decentralized systems 128 storing data for the system for the user's email address, portable ID 130a, or phone number associated with an account and validate. To authenticate the user, the support or virtual agent of the entity or the system, may trigger 402 the passwordless credential flow. Once verified, the user to ask more detailed questions of the agent(s) or proceed with a sensitive transaction or action.

Another advantage of certain exemplary embodiments of the system is a voice or SMS-powered large language model-powered virtual agent who may ask users to type in an email, phone number, pin, and biometrics, prior to optionally speaking with live support staff. Said agent may be trained on various onboarding, compliance, and regulatory data to support onboarding and client lifecycle functions and processes of the system. After successfully validating biometrics and/or the (meta) data, access and/or onboarding to systems, devices, databases, and applications, may be initiated and facilitated 404-410.

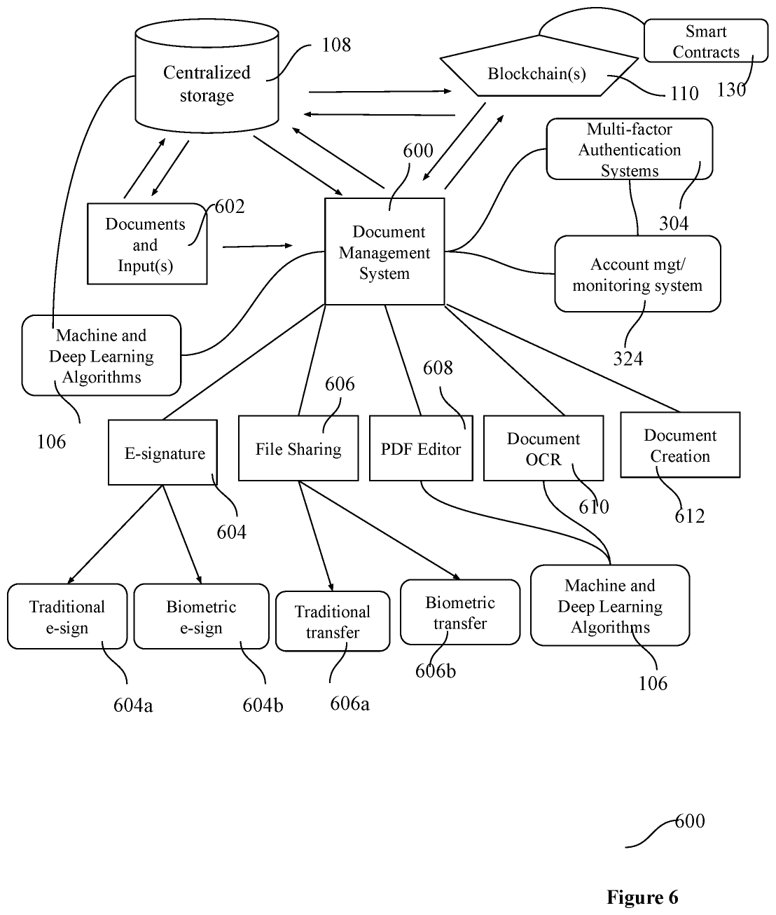

In certain exemplary embodiments of the system, a user may use QR code technology to access applications or functions within the system or 3rd party systems For example, a desktop 320 user being onboarded or trying to gain access to an account may be asked to access the app version 320 (via biometrics and/or pin functions, traditional password) of the system to continue the onboarding or authentication process by taking a picture of a QR code. The system may allow to onboard or authenticate process on once device and transition to another device by taking a picture of a QR code associated with their existing onboarding or authentication attempt. Referring to FIG. 6 is an architecture diagram illustrating document management systems according to certain exemplary embodiments of the system. An advantage of certain exemplary embodiments of the system is an integrated onboarding and client lifecycle management system that may integrate identity and document processes. In certain embodiments—during the processes of having biometrics 124 and identity 306 verified, maybe a document exchange process 410 takes place.

Certain exemplary embodiments of the system may utilize identifiers created by the system and/or introduced to the system, for automatic reconciliation of document information with identity data and metadata aggregated by the systems 108/314. In certain exemplary embodiments, client-side interfaces and applications 302 may be available that allow the exchange of 604-606 of various documents and document types. The system may automate various reconciliation and audit processes of onboarding and client lifecycle processes—i.e., documents may be automatically synced to the underlying identity profile.

In certain exemplary embodiments of the system, a document management system 600 may enable users and entities to efficiently exchange 604-606 documents while being onboarded 410 and throughout the lifecycle of the relationship via the ability to receive/send 606 and digitally sign/exchange 604 legally binding agreements/documents. Expanding on certain exemplary embodiments, if an admin uses the e-signature system 604 to send a document, once the document (link) is clicked, (meta) data about the signatory comprising device type, browser type, and IP location may be gleaned by the system and stored 106. This may enable an entity or system to ask additional questions to a user who is signing documents from a different location and/or device that has not previously been used to engage the system. The client-side interface(s) 302 of certain exemplary embodiments of the system may allow users to automatically see the signed documents reconciled alongside other onboarding 400 data captured or retrieved by the system that is associated with said user.

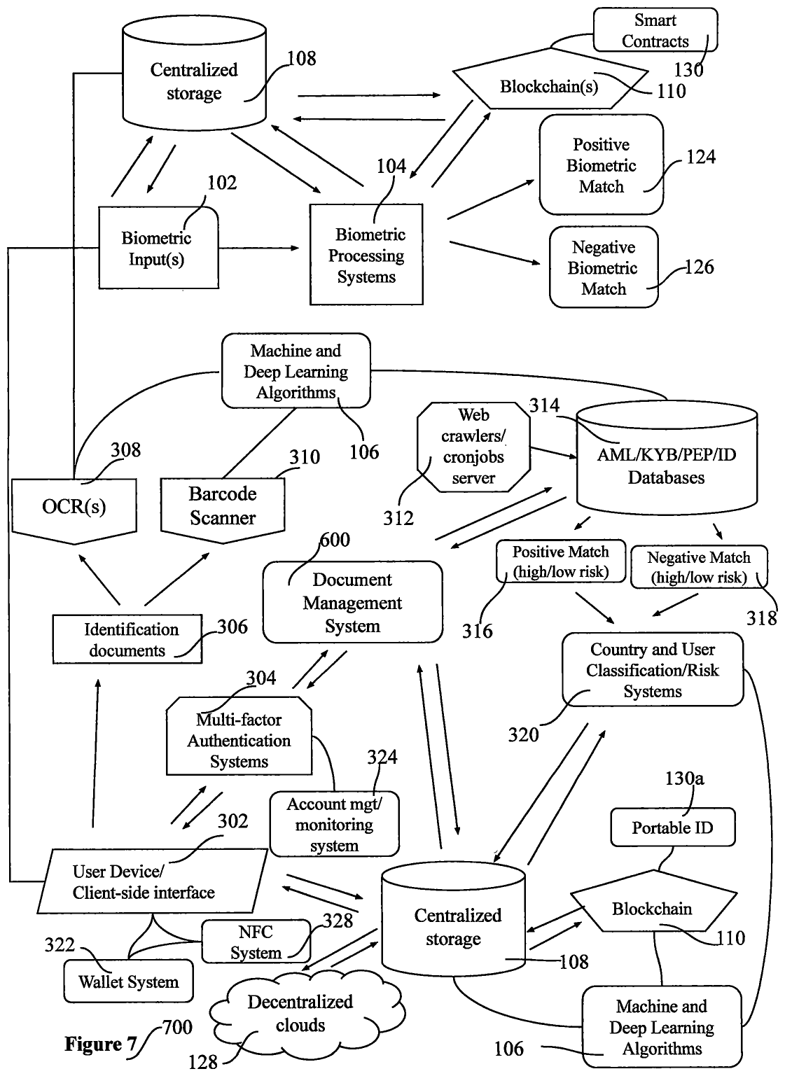

Referring to FIG. 7 data flow diagram, according to certain exemplary embodiments of the system—the identity and document management systems may enable data stored in centralized 108 and/or decentralized systems 128, to be printed, copied, extracted, transferred, exported, and download with other internal and external admin utilizing the system. Another benefit of certain exemplary embodiments of the system is an (audit trail) of signed and shared documents on a blockchain of/or utilized by the system 110 by saving a transaction hash, and/or smart contract 110 that may be associated and executed when a document has been signed or successfully transferred. In certain exemplary embodiments of the system, the system may have programmable agreements utilizing smart contracts 130 that interact on blockchain 110 networks to confer and execute the terms of the agreements in a programmable manner. The sender of the document may consider the document as being signed and the agreement consummated once the private/private keys have been signed (biometrically or digitally) executing the smart contract agreement.

The document management system 600 may comprise the ability to add text, whiteout text, delete text, comment, highlight, create new fields, checkboxes, underline, stamp, insert and eliminate pages, and add signatures, and initials. PDF and other document types pages may be reordered, rotated, merged, and consolidated. Documents may automatically and routinely be saved and stored over certain intervals to prevent loss of edits—with synchronization happening across multiple devices. The system 600 may enable users to annotate and edit PDF documents 608 that may accept various document types including but not limited to .jpgs, .pngs, and .pdfs, among others

In certain exemplary embodiments of the disclosure, an immutable audit trail may track every core activity within the document management system 600, including but not limited to documents being sent, signed, uploaded, read, renamed, ported, shared, and voided. Enabling users of the system to verify and validate all actions of the system in a dynamic and chronological manner and immutable 110 manners. A benefit of certain exemplary embodiments of the system is that documents may be transferred securely to internal or external users with and/or without permissions 606. Another benefit is that the system may enable one or multiple signatories to sign 604 documents. The system 600 may allow for documents to be uploaded, dragged, and dropped 602, or imported or exported into/out of the system via Dropbox, Google Drive, and other centralized 108 and decentralized cloud storage 128, in a variety of document types—DOC, XLS, PPT, PNG, JPEG, DOCX, among others.

A unique benefit of certain exemplary embodiments of the system is a system that may enable users to auto-fill documents via API with information that is hosted and stored by the system's centralized 108 or decentralized storage 128. Various information about the user signing/transferring 604-606 the document may be acquired during the viewing, transfer, and signature processes, including but not limited to IP addresses, time of opening, and last time read, among others. Information aggregated may be cross-referenced against other variables stored inside or outside of the system.

For entities comprising banks, brokerages, financial advisors, or insurance companies, documents exchanged 410 may be an account opening document or terms of service for the account or loan; for a residential or commercial real estate landlord, this document may be the lease agreement for the property being rented or purchased; for gig-economy companies, the document may be the delivery driver or transportation drivers contractor agreements; for an employer, this may be the employee offer and stock purchase agreement for the employee; for a DMV or other municipality service provider, it may be the annual renewal documents for driver's license or driver's tabs.

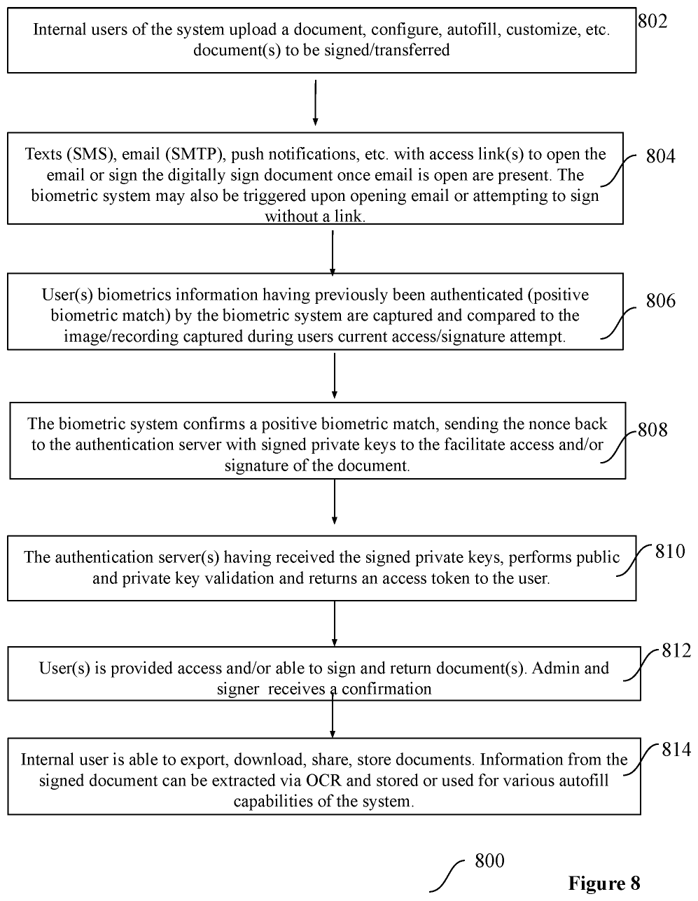

Referring to FIG. 8 is a flow process depicting exemplary biometric e-signature and file transfer systems according to certain embodiments of the system. One advantage of certain exemplary embodiments is a document system that may utilize data that has been stored in the systems databases 108/314 or blockchain 110—i.e, biometric data and/or image(s) from IDs as an authentication and verification mechanism, for documents being e-signed 604b and transmitted for sharing 606b. The system may use PIN, passwords, email, or biometrics for access and authentication to documents. Authentication may happen at the beginning but may be triggered or prompted at the end of the document transfer or signing process. In this way, an entity may confidently send documents to users and ensure that the legally responsible party is verified. The system may use methods comprising PIN whether numerical or alphabetical code or a combination thereof, for document access as well. These methods may be used in conjunction or combination with biometric means of authentication.

In certain exemplary embodiments of the system, a secure file sharing 604 and signature system 606 where XML Digital Signatures, X.509 public keys, PKCS #8 private keys, SHA-512 with 4096-bit RSA keypairs may be present. The system may utilize security measures including but not limited to, 256-bit AES for data and document encryption, or BCrypt for password hashing. For connectivity security, HTTP, TLS/SSL, SMTP, IMAP, NTP, DNS, etc. may be employed.

An advantage of certain exemplary embodiments of the system 700, is that information may be extracted via OCR(s) 308/610 of the system to auto-populate documents being sent or received—i.e., a bank statement or ID 306 may be uploaded with information that may be extracted via OCR(s) 308. Information that may be used to auto-populate 602 the agreement form that is signed 604 at the end of the onboarding process 410 with the users' information, helping to limit manual data entry errors. Information extracted by the OCR 308/610 includes but is not limited to the first name, last name, address, date of birth, tax information, SS #, EIN, account information, and credit information.

Information from signed and returned documents may also be extracted via OCR 610 for various internal processes and sent back to the recipients' database via API. Information may be fed to the OCR 308/610 via API or via manual upload (drag and drop). The OCR 610 may be multilingual, enabling smooth usage from a variety of end-users. In addition, information from signed and returned documents may be extracted via OCR 610 and stored in a centralized 108/or decentralized storage 128. A visual depiction of the document may be viewable by interface 302 of the system and downloaded or exported in a variety of different formats, securely.

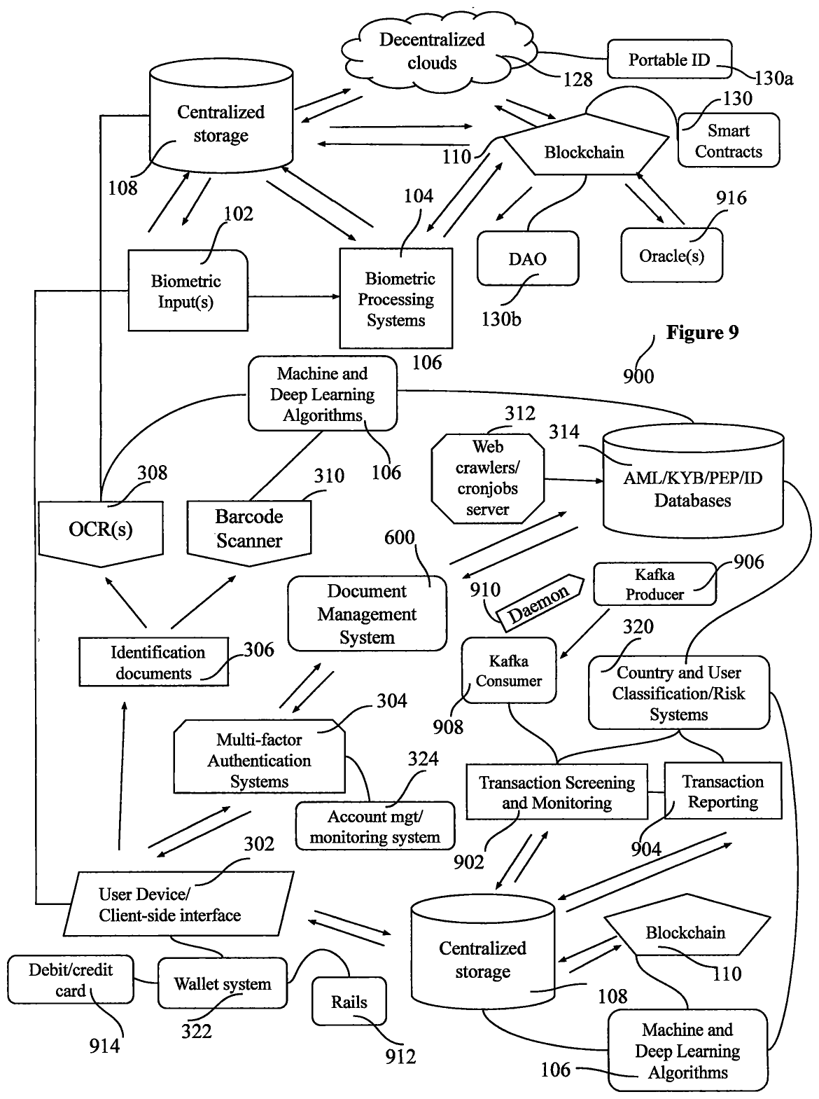

Referring to FIG. 9 is a data flow diagram depicting identity, document, and transaction management systems according to certain exemplary embodiments of the system. In these certain exemplary embodiments, a transaction management system 902-904 may monitor, screen, track, report, and learn from (meta)data comprising transaction value, frequency, type, risk, location, currency, wallet type, asset type, protocol, time/date of the transaction. (Meta) data may be aggregated 102, stored 108-110/128, trained 106, and classified 320 in likely or unlikely groups and categories that may be automatically or pre-derived by the system or users of the system.

A benefit of certain exemplary embodiments of the system is a transaction management system that may ingest 108/314 the data previous or currently being aggregated to train (remotely, cloud) models of machine and/or artificial intelligence 106 in intervals or continuously, to allow the system to learn for processes and functions pertaining to transaction screening 902, fraud detection/prevention 902, and anomaly detection 106. Data aggregated may be stored in databases 108 on the server(s) of the system and/or via external databases that may be remote or cloud-based. Databases 108 of the system may leverage SQL and/or NoSQL schemas for storage—databases 108 may contain fixed or variable schemas to define how data is to be stored and categorized by the system. Data may be consumed by the transaction management system in a variety of ways, including but not limited to manual import, API, FTP, webhook, and messaging brokers.

In certain exemplary embodiments of the system 900, a data pipeline may be utilized that ingests transaction data via API and/or messaging broker(s) comprising Apache Kafka 906-908 or RabbitMQ and stores it in the systems databases 108 as transactions are screened and monitored. The messaging brokers 906-908 may allow the system to streamline the receipt of information in a continuous fashion. The messaging brokers 906-908 of the system may contain a producer (send of messages) 906 and/or consumer (receives messages) 908.

In certain exemplary embodiments, the consumer(s) 908 may parse transaction data received before storing the data in databases 108. Once parsed, the transaction data may be stored by schema(s) that may be linked to one or more feeds or topics. The producer(s) 906 may be hosted with the system, or hosted by the system of entities that produces the transactional data. A benefit of certain embodiments is a daemon 910 may be present that may use reconcile and transactions that may have been missed by the consumer 908 or not sent by the producer 906. The daemon 910 may alert producer 906 that certain information was not successfully posted to consumer 908, thus enabling the producer 906 to resent the missing transaction data.

In certain exemplary embodiments of the system, the consumer 908 may listen to a topic or feed for transactional data to be sent from the producer 906. The producer 906 may be hosted at the backend of the system and synchronized with the admin client-side interface of the system. In these embodiments, an import function may be observed that enables users to transmit transaction data into the system via import. In anticipation of transmitting transaction data to the producer 906, the client-side 302 interface and logic and algorithms of the system may be used to ensure data is being sent in an acceptable format. The system may utilize a conversion function (algorithm) to transform data imported via different file types into j son format prior to transmitting the transaction data from the producer 906 to the consumer 908. Once the data has been converted, an API may be used to communicate with producer 906, before sending the information from the producer 906 to consumer 908.

In the event NoSQL database(s) are being used, the data transmitted may be replicated across multiple databases 108-110. Before or after the information has been stored, a hash of the information may be created. A distributed ledger and/or blockchain-based technology 110 utilized by system may be used to store the metadata and/or data in an immutable fashion. The system may store a hash on-chain 110 with transaction data being stored off-chain 108.

In certain exemplary embodiments, the system may use a client-facing API to enable entities leveraging the system to POST information into centralized and/or databases 108 utilized by the system. API calls may also be used to GET information from the system. All endpoints of the system utilize authentication comprising OAuth, JWT, API, or some combination of the 3. In certain exemplary embodiments, systems APIs or APIs that interact with the system may utilize JSON Web Token (JWT) to authenticate other API requests or JWT with OAuth for higher security. External APIs may utilize API keys in their request in order to authenticate requests with the system.

One benefit of the transaction management system of system is that it may recognize various forms of transactions and transaction types, processing and transaction data that can be considered time-series data. For example in real estate applications of the system, transactions may be tied to rent and security deposits being paid; in credit card companies, transactions may be tied to debits and credits made by users; insurance company transactions may be linked to premium payments made by users; while a bank, brokerage, exchange, virtual asset service provider (VASPs), e-commerce, or payments company may have transactions tied to buying, selling, transferring, withdrawing, depositing, execution, clearing, and settlement of assets, funds.

In certain exemplary embodiments of the transaction management system, where payment, banking, brokers, exchanges, and VASPs may be concerned, SWIFT and FIX APIs may be used to transmit information. In scenarios wherein SWIFT and FIX APIs may be used, initiator (sends messages) and acceptor (receives messages) SWIFT and FIX engines may be present, allowing the system to digest data leveraging the SWIFT and FIX protocols.

Another benefit of certain exemplary embodiments of the transaction management system is that it may recognize and support various forms of asset types. The system is one that may execute, track, and screen 902 both traditional assets and digital (virtual) assets. Assets executed, tracked, and screened by the system may be hosted in centralized 108 or decentralized 128 systems. The transaction management system may utilize blockchain 110 transaction data sourced by running a node of the respective blockchain 110, or via a 3rd party websockets or APIs that provide the system with information from the blockchain110.

For example, in certain exemplary embodiments, an entity may POST metadata or data related to a blockchain 110 transaction in data storage108 associated with the system. This information may be used to query a 3rd party API to GET the transaction information directly from the Ethereum blockchain110, before posting that information to the database 108 tied to the transaction management system. In another example, a node of the system that is running the network may listen for transactions tied to wallets 322 monitored by the system with the transaction data fetched from the node running the blockchain network 110.

A benefit of certain exemplary embodiments of the system is a transaction management system capable of detecting different typologies 106 and mitigating false positives during the transaction monitoring and screening 902 processes. The system may use supervised and/or unsupervised artificial intelligence 106 to mitigate false positives. Another benefit is a transaction management system capable of positively identifying known money laundering typologies including but not limited to fan-out (single sender and multiple receiver accounts), fan-in (multiple senders and single receiver accounts), scatter-gather (main account distributes money to several members and members send most of the received money to a single account), stacked bipartite, bipartite, etc. via machine/deep intelligence 106.

In FIG. 9 an exemplary embodiment of the system may utilize identity, document, or transaction data contained and/or extracted from centralized 108 or distributed ledgers 110 to train supervised and unsupervised forms of machine intelligence 106. In certain exemplary embodiments of the system, aggregated information may be grouped, labeled, and stored for training. Ideally, splitting the data into a testset and training set for learning purposes via backpropagation (or other methodologies) is administered batch, gradient, stochastic gradient descent, or a combination. The system stores messages and requests, and uses classification 320, clustering, and other types of supervised and unsupervised algorithms 106 to create various bundles, groups, layers, or information to optimize the identity, document, and transaction management systems 900.

In certain exemplary embodiments of the system, to manage and automate compliance reporting tied to transactions, the transaction reporting system 904 of the systems transaction monitor may automatically file Suspicious Activity Reports (SARs) and Counter Terrorism Reports (CTR) with FinCEN and other regulators. The system may provide a front-end interface 302 where client(s) transactions may be visualized in a dashboard interface. This may enable entities to manage their SARs reporting in a concise manner. The system may auto-fill parts of the SAR/CTR/Travel Rule forms via API leveraging information extracted during the onboarding phase comprising first and last name, address, DOB, and address, among others. The system may utilize the large language model agent, and/or any other natural language processing systems of intelligence for auto-filling and creating SARs reports.

An advantage of certain exemplary embodiments of the systems is reporting capabilities that may enable various transactions 904 to be reported. For example, residential real estate companies, credit card companies, and insurance companies that utilize the system may report transaction information to credit rating agencies to enable the people using their platforms to build their credit once transactions have been successfully processed. Users may use their transaction details to file their taxes. Brokerages, exchanges, and VASPs that utilize the system may use FIX API to report transactions to various trade reporting facilities using an initiator FIX engine to send messages to an acceptor to receive confirmations.

In certain exemplary embodiments, the client-side interfaces 302 of the system provide user interfaces for both admins of the system and users of the system to share and view information tied to the identity, document, and transaction management 900 capabilities of the system. The admin interface enables admins to view, edit, add, delete, approve, reject, mint IDs, share profiles, import, and export identity, document, and transaction information. Admin panel information may comprise cumulative financial data about clients, an overview of total investments, performance, and allocation data for assets and portfolios, investment plans, investment policy statements, recent activities of clients, a timeline of client notifications, client investments, and transactions. The admin panel may group users of the system by various categories using classification from system 320 comprising risk type, country, user score, or other statuses to segment users and enable entities to manage their users and their data accordingly.

In certain exemplary embodiments of the system, an admin panel interface where users that are approved, pending or rejected by the identity system may be found. A benefit of certain exemplary embodiments is an admin panel that may display users' data, enabling the admin to sort (in ascending order or descending order), filter by document type 306 uploaded (driver's license, passport, national ID), status (rejected, pending, approved, escalate), country risk score, user risk score, date submitted, first and/or last name. The system may support different users for entities comprising super admin, admin, admin-member, and members. Providing backend controls and configurations based on user, department, or function—i.e., an admin may be the only one able to delete a user, change a user's status, or provide certain permissions to other admins that are invited. The login activity, location, and device classifications of the system may empower the monitoring of access to the admin panel changing of other sensitive information.

A benefit of certain exemplary embodiments of the system is a system that may enable the porting of identity, document, and transaction information between centralized and/or decentralized storage 128. The system may spur the portability, reusability, and interoperability of onboarding and client lifecycle information. Providing encrypted storage of information, wherein private keys may decrypt certain information after attestations from the owner of a wallet 322 linked to a portable identity 130a. In certain exemplary embodiments of the system, the identity of a person, business, and/or government entity may be synchronized with the information captured during the onboarding process.

In certain exemplary embodiments of the system, the system may be blockchain 110 agnostic, allowing the portable identity 130a to be linked to at least one identity and at least one wallet 322, on at least one blockchain 110, irrespective of the underlying chain of the non-fungible token and the wallets 322 being linked to the ID. In certain exemplary embodiments, the smart contracts 130 utilized by the system may run on a native blockchain 110. In certain exemplary embodiments, smart contracts 130 may run on a native blockchain 110 and on other layers 1 or layer 2 blockchains 110. The transaction, document, and identity data, metadata, and/or hashes may be replicated on nodes across a private, consortium, public network, or a combination. In order to validate transactions within the network, a group of predetermined or authorized nodes (computers, laptops, servers) may be observed. In certain exemplary embodiments, to maintain anonymity for users of the system, only predefined nodes may be able to view the total aggregated content of the blockchain110. Data may be distributed among nodes of the network creating an immutable audit trail.

In certain exemplary embodiments, users may have the option to run different types of nodes (master, full, light). A masternode may have multiple functions within the system, including but not limited to validating transactions, creating new blocks, managing voting events, governance, and providing execution of protocol operations, among others. Masternodes may be online 24/7, as a result, they require more maintenance, storage space, and memory. In order to run a node(s), an entity may be required to deposit a minimum amount of fiat, digital, virtual, and cryptocurrency as collateral. Collateral may be seized in the event a node violates the rules of the blockchain 110. Entities of the system may run full nodes or light nodes. Full nodes contain a full copy of the blockchain's 110 transaction history, while light nodes may contain a segment or portion of the blockchain's 110 transaction history.

Once validated, data may be grouped into blocks and stored on chain 110. Nodes of the system may be connected and constantly exchange the most recent blockchain data, ensuring all nodes stay up to date. Once a validator (master) node accepts a new block of transactions, it is added to the existing blocks. Nodes can be online or offline. Online nodes (typically master and full nodes) receive, save, and broadcast the latest blocks of transactions to other online nodes. When an offline node comes online, it may download all blocks that were added to the blockchain 110 since the node went offline in order to synchronize with the other nodes.

The sequential linking of blocks within the system's blockchain 110 ensures immutability and the information contained therein. For each entity running a node of the ecosystem, a copy or partial copy of all transactions may be readily available. Private smart contracts 130 may enable data to be encrypted ensuring anonymity for users, wherein participants may only view metadata pertaining to the said participant. Entities may control access to ledger data at a department, function, regulator, employee, and user permission level. Ensuring a variety of end-users access to a single source of truth. Each transaction recorded and stored within blocks on the blockchain 110 may be time-stamped, creating an immutable trail for entities of the network to monitor, account for, and extract historical information from the distributed ledger through a variety of compliance reporting-related queries. disseminated geographically, nodes of the system run a copy of the network blocks (transactions), creating highly secure, transparent, and dependable record keeping.

In certain exemplary embodiments of the system, identity, document, and transaction information may be distributed across a multitude of nodes that may be incentivized to validate transactions (information) and create a new block aggregated with the transactions (information). Each block of the chain of the system is linked cryptographically. Data and metadata of the blockchain 110 may be encrypted using the most advanced security measure (SHA256) to maintain anonymity for counterparties transacting on the network. Each node(s) (master, full, light) may be hosted strategically using machines of supervised and unsupervised intelligence to minimize network costs and maximize geographical distribution while maintaining optimal scalability and security. In certain exemplary embodiments of the system, a frontend interface where entities can view prebuilt standardized reports or create their own based on queried data from the blockchain 110 in order to streamline compliance and regulatory process may be present.

Once a new block of validated transactions is minted, that information may be communicated to nodes throughout the network. A benefit of the system is a blockchain 110 where smart contracts 130 may be utilized for storing identity, document, and transaction information or a hash of said information on the blockchain 110. To ensure anonymity and privacy for transactors of the system, on-chain 110 cryptographic mechanisms comprising private smart contracts 130, ring signatures, stealth addresses, and mixing, may be utilized. To protect on-chain 110 and/or off-chain 108 identity, document, and transaction data, cryptographic tools comprising zero-knowledge proofs, zk-SNARKS, and Pedersen commitments may be leveraged. Off-chain 108 privacy layers comprising trusted execution environments (TEEs) may be utilized by the system.

In certain exemplary embodiments of the system, personal information may be hashed in order to protect the anonymity of the underlying. As a result, a user may be asked to decrypt certain information linked to the portable ID 130a that may prove identification in a zero-knowledge manner—without exposing the underlying data associated with the ID. In these exemplary embodiments, a hash of the encrypted information may be recreated by the user providing attestation to the underlying variables by verifying the hash. The underlying information need not be viewable by any 3rd party to provide validity, as 3rd parties may take the hash and compare it to hashed information stored centrally, tied to the portable ID 130a, in decentralized storage 128 tied to a portable ID 130a, or in the decentralized data oracle 916, as an attestation to the validity of the underlying information without viewing it directly.

In certain exemplary embodiments, the system's portable ID 130a and associated identity, document, and transaction data and metadata in the systems or 3rd part decentralized storage 128 may function in conjunction with a wallet 322 that may be interoperable with multi-chains. The wallet 322 of the system may be used to control and custody assets (fungible or non-fungible) that are tokenized and/or digitized on the system's blockchain 110 and/or other blockchains 110 compatible with the aforementioned. The wallet 322 may have a private and/or mnemonic key used to sign transactions prior to initiating and triggering certain actions. The mnemonic key may be used to import existing wallets into wallet 322 of the system for ease of use between all wallets of an entity.

A benefit of certain exemplary embodiments of the system is the self-custody nature of private keys, wherein users may control all underlying fungible (ex: currency, stocks) and non-fungible (ex: identity, title, NFT) within a wallet 322 Said wallet 322 may have a public wallet address that may be used to identify and transact. The wallet 322 may also be linked to a naming service (ex: ENS). The wallet 322 may have payment functions (sending/receiving payments, paying fees, receiving rebates/returns), trading functions (buy, sell), and clearing/custody functions (margining, escrow, multi-signature), biometric and ID verification, among other things.

In the wallets 322 of certain exemplary embodiments the disclosure may be utilized when assets are digitized on the systems or another blockchain 110, or when the underlying assets are held outside of the system but may be under the control of the system via permission of the user—multi-currency wallet 322. The wallet 322 may be used to reflect assets held in a traditional account, enabling the assets in the traditional account to be digitized/tokenized to utilize the various functions and capabilities of the system's wallet 322. Assets held off-chain 108 may be in escrow and/or multi-signature type accounts, or otherwise within control or changeability by the system via permission or authentication methods employed by the system or 3rd party API and SDKs utilized by the system. Thus allowing the system to control assets held off-chain108 to properly reconcile with on-chain 110 activity.

In certain exemplary embodiments of the system, a system for implementing NFC specifications and communication systems for wireless short-range data exchange may be leveraged. Said NFC devices and tags 328 may be embedded. NFC devices 328 compatible with the system may have antennas that serve as inductive power receivers for communicators, wherein energy is provided by the NFC reader 328 as needed, without limitation. NFC devices 328 may be embedded in plastic or paper, enabling persistent memory, wherein memory may have standardized formats and commands for storing NFC data in at least NFC Data Exchange Format (NDEF). In certain embodiments, the NFC devices 328 may have specific commands per application. While in other exemplary embodiments, NFC communication for embedded devices may utilize microcontrollers of the embedded device for information exchange.

Expanding on exemplary embodiments of the system, logical link control protocols may be used for allowing multiplexed communication between at least two NFC devices 328. Service access points may serve as transfer mechanisms, enabling at least one peer to send protocol data units at any time—asynchronously. In certain exemplary embodiments, the service access point may be split into at least two parts, wherein each service access point address may convey various insights into the communicating devices.

In certain exemplary embodiments of the system, simple NDEF exchange protocols may be used to enable two NFC devices 328 to exchange NDEF messages. The NFC protocols compatible with the system may be stateless request/response-driven protocols, wherein the client may send a request to a server, and the server may process aid requests and return a response. A benefit of certain protocols and messages communicated the system is the ability to communicate maximum information units supported by a data link connect that is established between client and server.

The wallet 322 and non-fungible identities 130a utilized by certain exemplary embodiments of the disclosure may be linked with wallet 322 or physical (debit/credit) cards 914 to enable use in commercial transactions and onboarding in-person, online, or in the metaverse. Contingent to the exemplary embodiment, the cards may be linked to the portable ID 130a by QR code and/or NFC technology, serving as a payment and/or identity gateway whenever the QR code or NFC card, tag, etc. 328 is exposed. In certain exemplary embodiments, the wallet 322 of the system may have an NFC and QR reader/transmitter 328 that may enable seamless onboarding and payments with compatible devices. Linking said payments to the portable ID 130a by saving transaction details to a centralized system, blockchain 110, and/or decentralized storage 128. Payments transmitted via the wallet 322 and/or portable ID-linked NFC card 328/914 may be facilitated by fiat and/or cryptocurrencies.

Different trading, investing, remittance, (re)payment, tax, reporting, or credit-related transactions may be facilitated via client-side desktop and mobile wallets 322 of the system. Off-chain 108 reporting and metadata may be synched via unique identifiers from the centralized cloud to the decentralized storage 128 to enable the portability and immutability of said information. Information may be linked to a portable ID 130a, and off-chain 108 information may be routed to decentralized storage 128 for data duality.

As an example of the dynamic nature of certain exemplary embodiments of the system, a credit card company may use the identity management system 900 to onboard a user, once the user is onboarded and has imported their wallets 322 or off-chain 108 account information (ex: via open banking), a portable ID (decentralized ID) 130a may be minted on at least one chain, with data and metadata linked to the portable ID 130a on-chain 110, and optionally in decentralized storage 128 and/or oracles 916. The private keys may be used to sign on-chain 110 and/or off-chain 108 documents, wherein signed documents may be routed by at least a unique ID and stored in a centralized and/or decentralized storage 128 and associated with the portable ID 130a. The payment or credit card 914, credentials, NFC 328, and/or QR code details may be stored in decentralized storage 128 and may be linked directly or indirectly with a portable ID 130a. Off-chain credit and/or debit card transactions may be routed via at least one unique identifier to centralized and/or decentralized storage 128 to facilitate payments/transactions tracking, synching, and portability.

In another example of certain exemplary embodiments of the system, once the user makes a successful monthly payment to the credit card company, the payments may be reported to on-chain or off-chain 108 rating credit rating agencies, oracles 916, creating a change to a user's credit rating data and metadata tied to a portable ID 130a that may be stored centralized and updated in the decentralized storage 128 before or thereafter, or solely in the decentralized storage 128. Information may be queried from decentralized storage 128 via RPC endpoints. In certain exemplary embodiments, the system may serve as a “One-Click” payment credential, for example—a button may be clicked, or a QR code may be scanned, NFC card may be tapped, triggering the prompting attestation by the system, wherein a successful authentication via biometrics, private keys, etc. may enable the decrypting of payment credentials and/or trigger on-chain 110 and/or off-chain 108 execution, clearing, and/or settlement transactions.

In certain exemplary embodiments of the system, local rails 912, wire transfers, and foreign exchange systems may facilitate the origination and processing of payments made via the wallet 322, cloud, or desktop applications of the system. The payments system 912 enables users to send money from their bank accounts using their routing number and account number. The payment 912 system utilized may authenticate users from information provided or extracted during the onboarding process. Furthermore, the system may utilize internal or 3rd party open banking APIs and SDKs to fetch users' financial information directly from their accounts which may include a user's routing and account information to facilitate payments. This may enable the system to ascertain the balance of a user account in real-time, thus allowing the user and system to facilitate secure payment settlement for users of the system. The system may also provide the real-time balance for validating the issuance of onchain or digital assets that may be backed by the off-chain 108 balances.

In certain exemplary embodiments of the system, information collected, derived, or generated during the onboarding process 400 may be used to create classifications of a user that may be leveraged by the wallet 322 of the system for decentralized lending and trading protocols for (semi) permissioned onboarding. Enabling decentralized finance protocols to properly vet users without assuming onboarding and client lifecycle responsibilities of the system. These protocols may leverage the various classifications generated by the system.

For example, on-chain 110 and off-chain 108/314 information aggregated on the user by the identity (ex: biometrics/government ID), document (ex: tax documents), and transaction (ex: bank account and crypto wallet balance) management system may be processed via normal logic/algorithms or machine intelligence of supervised or unsupervised 106 to create financial credit or trustworthiness of a particular user. This information may be classified 320 and communicated using a variable(s) comprising credit scores, trustworthy scores, and linked to the entity's portable ID 130a. A benefit of certain exemplary embodiments of the system is a system that may use on-chain 110 and off-chain 108 data to get a more holistic view of a user's profile, allowing users of decentralized protocols to better understand who they are transacting with, while still maintaining user anonymity from the underlying protocol.

In certain exemplary embodiments of the system, identity, document, and transaction (meta) data may be synced to a verified identity via non-fungible smart contracts 130 that may be deployed on at least one blockchain (private, consortium, public, side-chain, L2)110 that support smart contracts 130—turing complete languages. A benefit of these certain exemplary embodiments is a portable ID 130a that may have on-chain 110 data tied to the portable ID 130a replicated and accessible via decentralized oracle, and/or decentralized storage 128 for various derivatives of personal, business, and/or government identity, document, and transaction (meta)data.

Personal data may be documents, videos, images, strings, bytes, of machine and human-readable format captured during the onboarding and/or client lifecycle comprising first name, last name, address, phone number, birth date, medical records, credit/debit card numbers, account number, (on-chain and/or off-chain) the credit score, user risk score, country risk score, face match, gaming statistics, the # of NFTs traded, assets (whole/fractional, tangible/intangible, liquid/illiquid), tickets, experiences, ID and certificate types (government, work, society/designation), nationality, liveness match, among others.

Business data may compromise employee data and metadata, work performance, trademarks, patents, access credentials, company name, business address, employee count, inventory, and freight data. Government data may comprise employee name, driving record, driver's license/tabs, renewal dates, criminal records, driving records, and tax records, among others. All of these may be linked to the portable ID 130a of any entity—person, business, or government onboarded by the system.

An advantage of certain exemplary embodiments of the system is a system that may be tied to at least one DID and/or non-fungible token(s), wherein data and metadata aggregated may be dynamic (credit score, rewards, points, heartbeat) or static (name, birth date, country of residence), contingent on the use case and application of services tied to the NFD ID. The portable ID 130a lifecycle may be dynamically and programmatically set or reset by the issuers via interfaces—ex: client-side, API, etc., prior to or after the portable ID/DID 130a is minted.

The DIDs (portable IDs 130a) of certain exemplary embodiments of the system may be paired and linked with additional DIDs issued by the system or 3rd party systems. Facilitating an interoperable synching of information and data via portable identities 130a of the system, irrespective of the prospective portable ID (DID) issuer or protocol. The syncing may occur on-chain110, decentralized storage 128, and/or oracle 916. In certain exemplary embodiments of the system, portable IDs 130a may be renewed after initiation and may be reinstated if previously lapsed, by completion of any action validating, verifying, authenticating said identity, document, and/or transaction decisional data points. In certain exemplary embodiments, additional wallet 322 may be linked to the portable ID 130a after minting via decentralized storage 128 by signing a transaction with the additional wallet 322. As such, the minting of secondary portable IDs 130a tied the new wallets 322 but the same identifier may be present.

A unique advantage of certain exemplary embodiments is a system where one component (identity, document, transaction) may be invalid, or one sub-component (credit, debit, passport, national id) within a component (identity, document, transaction) may be invalid, without invalidating the other subcomponents or components of the portable ID 130a. Irrespective of the degrees of separation, and without limitation. As an example, the employment ID tied to the portable ID 130a directly or via a separate DID 130a may expire without impacting the driver's license or passport components tied to the DID 130a.

In certain exemplary embodiments of the disclosed, a user may be asked to renew a KYC or upload a document once a year to keep the government ID sub-component of the identity component of their portable ID 130a valid. The system may automatically send a prompt via mediums comprising SMTP and/or SMS to update a portable ID 130a prior to expiration. Users may remotely conduct a KYC via the identity system 100, enabling the systems to validate the driver's license, while portable ID 130a data and metadata may simultaneously or sequentially be reissued and/or updated on-chain 110 by minting a secondary portable ID 130a and/or updating the existing portable ID 130a data. Contingent on the exemplary embodiment, updating of information may happen via centralized systems, on-chain 110 consensus, decentralized oracles, and/or decentralized storage 128.

In certain exemplary embodiments of the systems, portable IDs 130a issued may be non-transferable from the master wallet 322 (account). While in other exemplary embodiments, it may be transferable only to wallets 322 (accounts) linked to a verified identity, wherein said wallets (accounts) were previously imported or synched to the portable ID 130a during the onboarding and/or lifecycle process. The portable ID 130a is one that may also be linked to virtual wallet 322 (accounts) which may serve as a pseudo wallet 322 (account) for identity—similar to the virtual cards linked to portable IDs 130a.

In certain exemplary embodiments of the system, a portable ID 130a may have subsequent wallets 322 linked to the portable ID 130a via decentralized storage 128. For example, once a user passes the KYC/KYB/AML process of the identity system 100, the user may import various wallet 322 types via client-side applications or API, by adding private keys or mnemonic phrases to import the wallets 322, validating and attesting ownership by signing a nonce or transaction. Thereby associating said owner with the previously completed KYC/KYB/AML. In certain exemplary embodiments, the system may assign a wallet 322 and private keys with or without saving, storing, or using private keys.

When synching wallets 322, identities, and portable IDs 130a, a session ID may be present, and at least one unique identifier may route the wallet 322 address(es) and/or chain the portable ID 130a is being minted with the personal information extracted during onboarding and client lifecycle—hashed and unhashed, and sync said data with the portable ID 130a data and metadata on-chain and/or decentralized storage 128. In certain embodiments of the system, an RPC endpoint may serve as a gateway for routing off-chain 108 identity, document, and transaction (meta)data and storing it by portable ID 130a in decentralized storage 128.

Validating, authenticating, and attestation of ownership may be observed by signing a nonce or transaction, thus associating the new data and metadata with the previously minted portable ID 130a by unique identifiers that may link new data and meta in decentralized storage 128 to unique DIDs of verifiable entities. The system may also enable the linking of wallet 322 (accounts); and identity, document, and transaction data that was synced via decentralized storage 128 to a DID minted on at least one other blockchain, with the minted DID on a separate chain being tied to the same verifiable identity linked via decentralized storage 128 and/or oracles 916. In certain exemplary embodiments, similar wallet 322 and address may be used for signing and validating transactions on multiple networks prior to at least one portable ID 130a being minted—i.e., EVM-compatible networks.

In certain exemplary embodiments of the system, various entities leveraging the system may route identity, documents, and transactions (meta) data fetched from centralized storage systems to decentralized storage 128 via at least one unique identifier tied to at least one portable ID 130a and off-chain data point. Spurring the decentralization and control of information, allowing users to understand and control identity, document, and transaction information aggregated by centralized 108 and/or decentralized storage 128. This information may be posted to decentralized storage 128 on permission, real-time, batch, and interval basis, allowing formerly centralized information to be made available via decentralized storage 128 and linked to a verified identity.

A benefit of certain exemplary embodiments of the system is that the system may enable access to information irrespective of any one cloud services provider's availability. Identity, document, and transaction information is often inaccessible at crucial times in developing countries. By enabling data types to be routed to a verifiable identity in the decentralized storage 128, users of the system may provide services that are not contingent on power or electricity—often scarce and unpredictable resources. This has large implications for entities across the industry as previously siloed information may be made available despite where information is initially controlled and/or processed.

As an example of certain exemplary embodiments, a user may be onboarded via the identity system by the doctor, once verified they may have various medical records or prescriptions added to their portable ID 130a that may be used by the pharmacist by exposing their portable via QR code of NFC tags, cards, and buttons 328. As another example, a user may conduct a DMV screening initiated via SMTP, text, or by scanning a QR code. Post onboarding, a portable ID 130a may be minted and linked to their identity to the decentralized storage 128. This user may now have verifiable credentials that can be fetched at any time via URI(s) tied to the portable ID 130a decentralized storage 128, but also their NFC cards, tags, and buttons, among others. This portable ID 130a may be made available to law enforcement during traffic stops by exposing a QR code, or NFC device 328, or by showing the certificate of various on-chain 110 data and metadata tied to a portable ID 130a in human-readable form. This decentralized identification may also have centralized information routed via the systems, enabling things comprising payment and medical information to similarly be available and actionable irrespective of underlying power conditions.

To avoid spamming and ensure the privacy of identity, documents, and transactions (meta) data to a user's portable ID 130a in decentralized storage 128, certain exemplary embodiments of the system may request permissions (attestation) from the owner(s) of the portable ID 130a prior to the information being stored, deleted, shared, renamed, moved, uploaded, downloaded, etc. Similarly, portable ID 130a owners may whitelist IPs, services, and providers that have the ability to pull information from their portable ID 130a without the need for manual attestation. The system may recognize the routing entity by a unique identifier comprising API keys or other means of authentication when communicating. In certain exemplary embodiments, off-chain 108 and on-chain 110 information may be fetched and routed to and from the DID, giving users control and access to their information for all services. The portable ID 130a may be linked to other portable ID 130a that have various data and metadata routed via RPC API, and at least one wallet 322 may be synched to a portable ID and the owner may control various rights, and privileges.

In certain exemplary embodiments, a portable ID 130a may be created and linked to a group of users who may control identity, document, and transaction (meta) data linked to portable ID 130a. For example, an organization has a business portable ID 130a minted and when employees meet the criteria for acceptance, they may receive access or privileges of the broader identity, document, and transaction data. Additionally, in certain exemplary embodiments, a portable ID 130a may be linked to an entity, whereas other members of the entity need shared access. The private master keys of the entity's master portable ID 130a may be unlocked (whitelisted) for the portable ID 130a of qualifying members, providing access and/or control of identity, documents, transaction data, and privileges. The system is one, wherein subcomponents tied to identity, document, and transactions may be transferable and non-transferable, with varying permissions, viewability, editability, and configurability, depending on the criteria and requirements of the decentralized storage 128 tied to the portable identity 130a.

In certain exemplary embodiments of the system, documents and transactions of any data or form may be tracked on a time series basis. For a person, that may be finances, health, or work-related; for business, a document or transaction may be financial, employee, competitor, inventory/product, performance, or regulation related; for governments, a transaction may be financial, resource policy, constituent, or interstate related. Transaction data and documents may comprise the number of transactions, type of transaction, transaction frequency, transaction recipients, transaction data, transaction size, transaction risk, transaction description, and counterparties.

Transactions may comprise rewards/points on a card or account, credit scores, payment history, number of miles flown, number of winning/losing bets, number heart beats per minute, miles driven on car, # social media posts, number of crimes committed, number of fungible or non-fungible assets owned, borrowed, loaned, sold, or the value of fungible and non-fungible assets owned, borrowed, loaned, sold. These data points in any format and file type may be linked and synched to the portable ID 130a, irrespective of the initial issuer of the portable ID 130a, or whether the information is one-time or recurring.

Documents and data may be digitally linked with the portable ID 130a of the system via decentralized cloud systems 128, irrespective of the initial issuer or minter of the portable ID 130a, or the underlying, whether individual, DAO 130b, business, and/or government. The owner(s) of the DID and its linked document and transaction credentials, documents, data, and metadata, may utilize none, one, or multiple private keys or biometrics for attestation that may be associated with portable IDs 130a and decentralized storage 128, in order to receive, send, or access (decrypt) decentralized identity 130a data (credentials), document (types/files), and transaction data (transactions/credentials). Certain personal, business, DA0130b, and government portable IDs 130a synched to identity, document, and transaction information and/or capabilities may require multi-signature—multiple signatories may have valid access to decrypted information or trigger an action.

A benefit of certain exemplary embodiments of the system is that off-chain 108 and/or on-chain 110 documents and transactions may be routed and tied to a portable ID 130a. In these exemplary embodiments of the system, portable IDs 130a may be minted on layer one (ex: ethereum) and/or layer two (ex: polygon) and tied to one or more wallets 322 that may have one or more portable IDs 130a on each layer of compatible or interoperable networks. Another benefit of exemplary embodiments of the system is a system wherein DIDs may be minted on private and/or consortium networks—permissioned networks, but document and transaction data and metadata may be hosted on decentralized storage 128, enabling a hybrid and robust architecture.

In certain exemplary embodiments of the system, an initial or secondary portable ID 130a may be synched with off-chain 108 accounts and/or devices (NFC, wearables, IoT) that may be hosted and maintained on other decentralized 128 and/or centralized systems 108 that may transact and aggregate and store data and metadata associated with a portable ID 130a before, after, or simultaneously to the execution of off-chain 108 transactions. (Meta) data may be stored via methods comprising POST API calls to an RPC endpoint that may receive the transmitted information via machine or human-readable formats prior to storing data centralized 108 or in decentralized storage 128 by routing and synching data and metadata to portable ID 130a, or at least one unique identifier of the system. Spurring information portability, control, and privacy.

In certain exemplary embodiments of the disclosure, biometrics linked to DIDs may be used as an authentication mechanism, triggering the decrypting of keys or signing of documents and transactions. A benefit of the system is that data may be stored locally or on centralized 108 and/or decentralized storage 128 for authentication. In essence, the return functions of URI may be a centralized cloud service, and/or decentralized storage 128 services that may not be taken offline or adapted. The system's flexibility provides optionality and ease of use for various entities and use cases that may link information temporarily but may not want certain information immutable for various reasons.

In certain exemplary embodiments of the system, a portable ID130a may be linked to payment and onboarding credentials that may be stored in centralized 108 and/or decentralized storage 128. The payment credentials may be depicted and reflected in a variety of ways—i.e., string, digital card, QR code, NFC card, tags, and buttons 328, enabling the system to initial onboarding and payment in person. In certain exemplary embodiments of the system, the portable ID 130a of a user may be used to authenticate the users within a network of businesses enabling commerce. The transactions may be made via centralized or decentralized payment methods, and transaction credentials and history may be linked to a DID, synching (meta) data to the DID by unique identifiers. Various rewards or perks tied to a user's shopping may be stored with the DID.

An advantage of certain exemplary embodiments is a system that may automatically reconcile and audit personal, business, or government transactions, providing an immutable audit trail that may serve as the basis for accounting and tax preparation and filing. The system may track various transaction types comprising buy, sell, transfer, withdraw, and deposit, for transactions whether traditional or digital, creating an immutable general ledger tied to portable ID 130a. The system may use logic based on the geographical location of the portable ID 130a holder to automate the tax filing process. Transaction details, whether stored centrally 108 or decentralized 128 may be queried by portable ID 130a and/or other unique identifiers, in addition to on-chain and/or off-chain logic and algorithms to automate the calculation of or short-term or long-term statements related to personal, business, or government cash flow, income, or balance sheet statements.

For example, in certain exemplary embodiments, a user may complete the KYC process and link various wallets 322 to their portable ID. Transactions tied to this portable ID may now be auto-aggregated transaction data across chains and protocols. Information may be queried from the blockchain 110, decentralized storage 128, or oracle to validate transaction details. The user may exchange and sign documents related to tax filing via file sharing and the eSign capabilities of the system. Utilizing private keys, biometrics, or traditional methods of digital signature(s) to sign the document before filing, and geolocation, devices, among others, may be captured to authenticate identities prior to filing. Tax documents may be routed and stored in decentralized storage 128 and linked to the DID post-filing In certain exemplary embodiments of the disclosure, identity verification may be completed, and a portable ID 130a may subsequently be minted, wherein a user links wallets 322 and accounts for transacting and/or transaction monitoring and screening. This DID may now link any generated and/or stored job records and results, academic/health exam records and results, charters, designation, degrees; DMV records, licenses, fines, various statements, agreements, titles, deeds, rights, royalties, transactions, rent, insurance, credit history, tickets, gift cards, rewards points, or other NFTs to the aforementioned.

A unique benefit of the system is that the new portable IDs 130a issued may be linked to previous DIDs without a separate onboarding at each entity requiring KYC, KYB, and AML. Information may be synched to the portable ID 130a via routing information to decentralized storage 128 to the portable ID 130a, and information may also be stored on a chain and linked to the portable ID 130a or may have credentials or certificates tied to the DID hosted stored in centralized 108 and/decentralized storage 128

Expanding on certain embodiments of the system—a new portable ID 130a may be minted by providing and authenticating the UUID or unique ID of a valid DID. For example, if a valid KYC is done by entity 1 (a brokerage company), and the onboarding standards of the portable ID 130a are acceptable at entity 2 (an insurance company), once the portable ID 130a from entity 1 is authenticated (ex: by signing w/private keys), entity 2 (insurance company) may issue a unique portable ID 130a that may retrieve identity, document, and transaction information for application or use case. Similarly, entity 2 may also use the same portable ID 130a and simply sync transactions to that portable ID 130a by entity 2's unique identifier.

The newly minted DID may serve as a link or branch of the parent portable ID 130a. Depending on the embodiment, if the parent portable ID 130a credentials become invalid (passport expired and no other valid document linked), the subsequent branches linked to the parent portable ID 130a may become invalid. For example, if the user did a new KYC at entity 2 because they knew the master portable ID 130a was set to expire, the portable ID 130aminted at entity 2 may become the parent, enabling the portable ID 130a tied to entity 1 to gain validity from the portable ID 130a minted with entity 2.

An advantage of certain exemplary embodiments of the system is that DMVs may utilize the identity, document, and/or transaction management systems for onboarding a renewal of drivers' licenses, and tabs, among other things. The system may serve as the verifier and issuer of government credentials—by minting a new portable ID 130a or tying new driving credentials to a previously minted portable ID 130a. In these exemplary embodiments, the user may remotely onboard—i.e, authenticate their identity (biometrics, geolocation, etc.) for issuance or renewal. The DMV may use the file sharing and e-signature capabilities of the document system to exchange the necessary motor vehicle registration identity and documents, while the user signs and authenticates them via methods comprising private keys, biometrics, geolocation, and electronic signature.

The DMV may then issue a digitized driver's license that may be stored in centralized 108 and/or decentralized storage 128. The new credentials may be linked to the original portable ID 130a with an updated URI, or a new one may be minted. Thus enabling the user in our example above to update their ID remotely, get access to the new credentials remotely, and continue onboarding. In essence, the ID may be renewed remotely, so that the valid ID may be issued in the URI tied to the portable ID 130a with a new portable ID 130a being minted or linked to the old one—directly or indirectly (branch).

Contingent on the exemplary embodiment, the system may allow new wallets 322 to be added to a portable ID 130a or mint a “branch portable ID” that is linked to the main portable ID 130a but includes new wallets 322 or accounts. The user, in this case, may redo some part of the initial onboarding and sign the transaction on-chain 110, to validate their identity. In certain embodiments of the system, the portable ID 130a may only be transferable to another wallet 322 in the main portable ID 130a, or another wallet 322 that was added thereafter, or is tied to a “branch portable ID” once the wallet private keys have been signed the transaction and/or been imported. Irrespective of whether the ID is on the same chain or ported (wrapped) to another chain wherein the portable ID 130a may be utilized with a compatible wallet 322—i.e, EVM compatible.

In another example of certain exemplary embodiments of the system, an organization may use the system to verify the identity of stakeholders, issuing them portable IDs 130a or using their existing portable IDs 130a to validate their identity. Said stakeholders may log in to meetings, access buildings, files, and networks, or access identity, document, and transaction information. The portable IDs 130a of the system may serve as a credential to the various systems, databases, applications, and networks tied to the company.

The system is one where the minting of portable IDs 130a may happen without the underlying verification being executed by the system. In certain exemplary embodiments, the system may receive user information in a machine or human-readable format, and the personal data information may be fetched or posted to the system to mint the portable ID 130a of the user on at least one chain. In these exemplary embodiments, the system may serve as a portable ID 130a minting service for 3rd parties looking to provide portable identification systems. Similarly, 3rd party providers may route information to the portable ID 130a after minting, utilizing the RPC gateway of the system for synchronization and storage of transactions and documents.

In certain exemplary embodiments of the system, zero-knowledge proofs may be present, leveraging priori and posteriori verification of facts to allow trustless attestation of datasets. The trust source may be a decentralized autonomous organization and/or governing body, reaching consensus once the system identity management system 100 completes an onboarding process. Certain embodiments of the system may utilize the Proof of Process consensus algorithm, which allows the system to validate a user's identity—biometric, identity card, and geolocation, among other requirements, as the user is onboarded by the system, in a fully (semi) automated, defined and repeatable manner.

An advantage of the exemplary embodiments of the disclosure, is a system that may enable data integrity, actor non-repudiation, proof of anteriority, and proof of context, across identity, document, and/or transaction data tied to the portable ID 130a. Data integrity of the system may trustlessly be maintained to ensure the accuracy and completeness of data throughout the onboarding process and client lifecycle. In certain exemplary embodiments of the system, identity data and metadata tied to the portable ID 130a may be hashed and/or unhashed on-chain—i.e., the first name, last name, address, phone number, birth date, user ID are hashed, while risk score, country score, country name, face match, liveness match, time submitted are unhashed.

In certain exemplary embodiments, the system may be blockchain 110 and wallet agnostic, supporting multiple wallets 322 tied to one or many portable IDs 130a across various blockchains 110, irrespective of the wallet provider, or composition of the wallet—hardware vs software. Exemplary embodiments of the system may designate a master wallet 322 that may serve as the main (master) wallet 322 of the portable ID 130a. This master wallet 322 may be interchangeable with wallets 322 imported before (after) the initial identity verification process.

An advantage of the system is a system wherein portable ID 130a may be used to link a user's identity, document, and transaction on any blockchain protocol wherein non-fungible identity tokens are compatible and ported. For example, a user may import an ETH, Polygon BSC, portable ID 130a on each of the chains individually by importing wallets 322 tied to those wallets 322 via any client-side application, thus tying them to his DID prior to minting; or may mint one portable ID 130a on ETH (or any EVM chain), and port it to another EVM compatible chain—i.e., via a bridge. Similarly, the user may mint on portable ID 130a tied to one chain and link the other chains to the portable ID 130a via decentralized storage 128, either initially or any time thereafter by signing a transaction/none. For portable ID 130a contracts that are ported, a separate smart contract (or the same) may be used to keep track of on-chain 110 identity, documents, and/or transactions on another the second chain 110, and data may be reconciled and ported on the primary chain where the portable ID 130a was minted once bridged, or via decentralized storage 128.

In certain exemplary embodiments of the system, a single portable ID 130a may be minted on a master wallet 322 synching imported or assigned wallets 322 to said portable ID 130a by utilizing decentralized storage 128, thereby linking secondary wallets 322imported or assigned to the master portable ID 130a that was minted, irrespective of the chain where the master portable ID 130a is minted. Utilizing decentralized storage 128 to store the wallet 322 information (chain, address, etc.) tied to the other wallets 322 the user imported that may be on other chains than the chain leveraged by the master portable ID 130a.

Information may be fetched via decentralized oracles 916 to link and sync information stored in decentralized storage 128. A benefit of certain exemplary embodiments of the system is a system where a user may import or be assigned multiple wallets 322, wherein each wallet(s) minted on the same or separate chain may optionally have its own portable ID 130a, or wherein one portable ID 130a is minted and may synch to wallets 322 on the same or another chain by storing metadata tied to that wallet 322 in decentralized storage 128, enabling decentralized validation of data and metadata across all wallets 322 and DID's associated with various entity types.

In certain exemplary embodiments of the system, where multiple portable IDs 130a may be minted on the same chain and associated with an individual wallet 322. The master wallet 322 (the first wallet imported tied to a specific chain) may serve as the master minter, enabling secondary wallet 322 (wallets imported after the master wallet tied to a specific chain) to receive portable IDs 130a via the master wallet 322. For example, if a user has 2 Ethereum wallets, 2 Polygon wallets, and 2 Solona wallets, the first wallet for each chain imported may serve as the master wallet, minting portable IDs 130a that may be linked to each wallet 322. The (meta)data tied to wallets 322 minted, irrespective of the chain may be stored in decentralized storage 128 to synchronize the identity, document, and transaction information across the chain.

In certain exemplary embodiments of the system, portable IDs 130a may be minted irrespective of chain, synching to multiple wallets 322 that may be imported and tied to a user's document and transaction (meta) data by at least one unique identifier. DIDs may be minted simultaneously, or sequentially. A benefit of certain embodiments is a system that may tie multiple portable IDs 130a issued (minted) by separate entities on single or multiple chains to a master or main portable ID 130a of a user on the master wallet 322 chains or each chain may have a master portable ID 130a. Creating the ability for various portable IDs 130a across multiple chains to be linked to the same identity, document, and transaction data and metadata. A benefit of certain embodiments of the system is a system wherein the minter (issuer) of the portable ID 130a, and/or the recipient may pay the gas for minting.

In certain exemplary embodiments, the criteria of the onboarding may differ. Leading to different levels of portable ID 130a. For example, social login KYC, work ID, driver's license, residential permit, identity card, passport, visa, etc. would each have different time lengths for validity and may have different renewal criteria and acceptance per use case. The portable ID 130a issued by the system may be assigned by a centralized or decentralized entity that may issue and manage the keys tied to a component of an existing portable ID 130a.

In these certain exemplary embodiments, the identity, document, and transaction information that may be sent and received by the portable ID 130a for that specific wallet 322 may be incrementally more vulnerable than in scenarios where keys are managed by the owner of the portable ID 130a. However, these exemplary embodiments may enable centralized or decentralized entities to monitor and/or track keys, and transactions associated with wallet 322 for anti-money laundering purposes comprising Travel Rule Compliance. Identity, document, and/or transaction information for a user may be queried by the receiving entity, enabling to sending entity to validate the request for information on the chain, prior to sending information to the receiving party, to enable travel rule compliance without the users' permission per se.

Expanding on certain exemplary embodiments, the receiving party may decrypt the identity information tied to the portable ID 130a and the on-chain 110 or off-chain 108 transactions. The execution of this may happen without any human interaction on-chain 110 and off-chain logic. For example, in certain exemplary embodiments of the system, an API may be triggered once a transaction occurs on-chain 110 of a certain value or type, with the information tied to the user portable ID 130a being used to auto-populate suspicious activity reports, which may be batch or manually submitted by the reporting functions of the transaction management system. Exchanges, brokerages, or virtual asset service providers who may be receiving or sending information off-chain 108, on-chain 110, or via decentralized storage 128 for compliance may have a portable ID 130a for their business. Enabling other entities to validate the portable ID 130a of the business prior to sending (decrypting) user information for the receiving. This may enable the on-chain 110 and off-chain 108 trackings and monitoring of Travel Rule requests.

In certain exemplary embodiments of the system, a decentralized data feed may be leveraged, spurring the aggregation and dissemination of on-chain 110 and off-chain 108 information. In these certain embodiments, the decentralized oracle 916 of the system may update based on the settlement interval of the chain in which information is being aggregated and fetched or some other predetermined interval. As a result, this may allow the decentralized oracle 916 to remain updated in real-time, irrespective of block speed, as data may update after the settlement of each block on respective networks wherein portable IDs 130a smart contracts 130 may be deployed. This may spur the decentralized oracle 916 to provide portable ID 130a (meta)data in another decentralized manner, in addition to enabling various on-chain 110 and off-chain services to query the oracle 916 by wallet 322 address, and portable ID 130a, among others in order to validate the identities.

An advantage of certain exemplary embodiments of the system is an oracle 916 that may serve as decentralized 110/128 means of providing portable multi-chain and off-chain 108 identification verification. Oracle 916 may query the various blockchains 110 by the contract addresses of portable IDs 130a to fetch and/or reconcile information on-chain 110 with what is stored in decentralized storage 128 or off-chain 108. In essence, the decentralized oracle 916 may serve to validate the information and provide that information to on-chain 110 and off-chain 108 entities verifying information tied to portable IDs 130a.

In an example of certain embodiments of the system, the oracle 916 of the system may be hosted by centralized entities, where the entities may solely host the information fetched by the systems oracle 916. In these exemplary embodiments, the decentralized oracle 916 nodes may be hosted by multiple entities associated with the system—who may also have portable IDs 130a, further decentralizing the storage of the information stored in the oracle, for higher data persistence and uptime. A benefit of certain exemplary embodiments of the system is a decentralized data feed that may allow multiple parties to store information auto-reconciled and aggregated across various blockchains 110 and/or decentralized storage 128, enabling persistent off-chain 108 and multi-chain availability for portable IDs 130a.

For example, a bank may query the oracle 916 or decentralized storage 128 of the system, and the owner of the portable ID 130a may be notified to provide permission to access their identity, document, or transaction information via SMTP or SMS, where access to information may be facilitated post attestation. In another example, a user may provide a QR code or NFC card 328 to a scanner tied to a building in an IoT city or building, and the scanner or sensor may query oracle or decentralized storage 128. Once queried, the user's phone number, which may be tied to the portable ID 130a, may receive a text message. Once the link is clicked or some other form of authentication takes place, the doors to the building may open.

Expanding on certain exemplary embodiments, the scanner or system may provide immediate access once the NFC card 328 or QR code is displayed, as the system of the scanner may run a decentralized nodes oracle 916 of the network, or have access to the decentralized storage 128 with data needed for authentication. As another illustration, a user at a bank may be asked to decrypt the decentralized storage 128 links tied to their portable ID 130a and provide a certificate that may contain a QR code to scan. Once scanned it may provide access to document or transaction data or metadata tied to portable IDs 130a, or prior to routing information to the users' portable ID 130a via the RPC gateway.

In certain exemplary embodiments of the system, on-chain 110 and/or off-chain 108 document and transaction information may be stored (ex: j son) and fetched from the decentralized storage 128 via POST and GET request, where a portable ID 130a or similar identifier(s) may be used to route and fetch various identity, document, and transaction (meta)data and documents linked one or multiple portable IDs 130a, enabling the decentralized storage 128 of various on-chain 110 and/or off-chain 108 information linking them to a portable identity 130a. An advantage of these embodiments is the linking and synching of off-chain 108 documents and transaction data, metadata, and documents with identities tied on-chain 110 and in decentralized storage 128, bridging the gap between storing documents and transactions occurring off-chain 108 with an on-chain 110 identity, further enabling access to data irrespective of the technology stack of users interacting with the system.

Expanding on certain exemplary embodiments, a bank may route bank statements and transactions to decentralized storage 128 that are linked to a portable ID 130a, where a digitized version or QR version of the card may be stored, allowing the portable ID 130a owner to receive a notification to view the updated state or to make purchases via QR code or NFT card, or other means of transmitting payment, that may be stored in decentralized storage 128. For example, a user may have on-chain110 and/or off-chain 108 collateral tied to wallet 322, in their portable ID 130a that may be used for an on-chain 110 and/or off-chain 108 loans. Using the system of system, the lending institution may track any off-chain (ex: via open banking) on-chain 110 movements (RPC call for the balance of wallet 322 address, and monitor and value changes related to funds used as collateral, calling in the loan in the event any activity triggered a repayment covenant.

As another example, an e-commerce business may have a portable ID 130a minted (or route transactions to an existing one) for themselves and their customers/suppliers, enabling documents and transactions to be associated with the portable ID 130a. These may comprise invoices, NFC cards 328, number of transactions, inventory levels, rewards, location, and device types, among others. Payment accepted by the e-commerce company may be in fiat or cryptocurrency, and both execution types may be available and tied to the portable ID 130a. This may allow the business to manage inventory data and payment information in a decentralized storage 128, where information may be immutable and available. Furthermore, the platform may reconcile fiat and crypto transactions related to inventory, whether the inventory is on-chain 110 and/or off-chain goods and services.

In certain exemplary embodiments of the system, decentralized autonomous organizations may be leveraged by the system to govern and manage the identity registrar of the system. The decentralized autonomous organization (DAO) 130b of the system may be smart contracts130 programmatically managed on-chain 110 leveraging smart contracts 130b or off-chain 108—operating agreements/bylaws. The identity registry may be controlled and managed by the DAO 130b.

Proposals may be passed by voters for any modifications to functions, thresholds, criteria, and regulations, utilized by the DAO 130b of the system. The functions of the identity registry may include adding, removing, and updating functionalities, allowing entities with DIDs to be added and classified within the DAOs 130b registry on-chain 110 and/or in decentralized cloud 128. A benefit of the system is that users may opt out of the DAO 130b registry via remove functions. The DAO 130b identity registration process may occur before or after the DID is minted. As an example, before the portable ID 130a is minted the DAO 130b may vote in an automated manner based on the criteria the person passed, failed, country, etc.

Contingent on the exemplary embodiments of the system, the DAO 130b may develop and vote on a multitude of criteria to classify and group various entities onboarded based on the results of their initial onboarding by the identity management systems of the system or 3rd parties, allowing the decentralized autonomous organization to determine the thresholds for a variety of variables captured during onboarding and/or client lifecycle management. For example, the DAO 130b may determine that for a user to be included in the Level 3 or Platinum level of classification, which may be level for the most vetted people of the identity registry, a user may pass face match, liveness check, ID check, gender check, age check, country check, without issue. The various thresholds and criteria considered by the DAO130b may be on-chain 110 or off-chain108, and certain transactions may be considered by the DAO 130b that may or may not be aggregated or considered by the onboarding and client lifecycle—identity, document, and transaction systems of the system.

Certain exemplary embodiments of systems DAO 130b may require a governance and/or utility token in order to make proposals within said DAO 130b. Time allocated for any proposal may be contingent on the deposit value for the proposal, allowing the DAO 130b to gauge and manage issues relative to importance per the decentralized autonomous organization 130b. The value or percentage of tokens for or against an issue may be issued in the determination of a Quorum or various thresholds used for vetoing and approving proposals of the organization. Proposers may receive base or bonus rewards for proposals adopted by the DAO 130b.

In certain exemplary embodiments of the system, users may query the identity registry endpoints to see if they have been registered or the status of various proposals. This may enable a decentralization of centralized decisions made by the systems centralized identity management system, spurring the decentralization of the system. Furthermore, members of the DAO 130b may run oracle nodes 916 that aggregate information on portable IDs 130a and portable ID contracts across various chains. This may enable the oracles 916 of the system to further decentralize. In certain embodiments of the system, the DAO 130b may be multi-chain 110, allowing members with portable IDs 130a across various chains to vote on issues on their chain, wherein information tied to votes may be verified on-chain 110 and optionally queried via oracles to reconcile voting data for the DAO 130b across chains 130.

A benefit of certain exemplary embodiments is an account and monitoring system 324 that may work in real-time, alerting/notifying internal and external users of the system on processes comprising emails, pending applications, deleted accounts, transaction size, fraud detection, and filing regulatory documents. Alerts of the system may be inherent, machine/deep learning 106, or rules-based, proving the flexibility needed for a variety of different users across a variety of different industries. Alerts of the system may trigger system actions, 3rd party system actions, or physical action from internal and/or external users; or may simply notify users of actions by the system or 3rd party systems, or the completion of an action by the system or 3rd party. Furthermore, messages may be transmitted via various message protocols comprising webhook, SMTP, SMS, MIMS, and API.

The foregoing disclosure is not intended to limit the system to the precise forms or particular fields of use in the disclosed embodiments. As a result, it is contemplated that a multitude of alternative embodiments and/or modifications to the disclosure, whether explicitly described or implied herein, are possible in regard to the disclosure. Having described embodiments of the system, a person of ordinary skill in the art will recognize that changes may be made in form and detail without departing from the scope of the system. Accordingly, this description is to be considered illustrative and is for the purpose of teaching those skilled in the art the manner of making and using various embodiments of the system. It is to be understood that the forms of the disclosure herein shown and described are to be taken as representative embodiments. Equivalent elements or materials may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, and “wherein” used to describe and claim the system are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting the system. All joinder references (e.g., attached, simultaneously, aggregated, connected) are only used to aid the reader's understanding of the system, and may not create limitations, particularly as to the position, orientation, or use of the systems and/or methods disclosed herein. Therefore, joinder references, if any, are to be construed broadly. Moreover, such joinder references do not necessarily imply that two elements are directly connected to each other.

Additionally, all numerical terms, such as but not limited to, “first”, “second”, “third”, “primary”, “master”, “main” or any other ordinary and/or numerical terms, should also be taken only as identifiers, to assist the reader's understanding of the various elements, embodiments, variations and/or modifications of the system, and may not create any limitations, particularly as to the order, or preference, of any element, embodiment, variation and/or modification relative to, or over, another element, embodiment, variation and/or modification. It will also be appreciated that one or more of the elements depicted in the drawings/figures can be implemented in a more separated or integrated manner, or even removed or rendered as inoperable in certain cases, as is useful in accordance with a particular application.

It may be apparent to one with skill in the art that the portable identity, document, and transaction management systems may be provided using some or all of the mentioned features and components without departing from the spirit and scope of the system. It may also be apparent to the skilled artisan that the embodiments described above may be specific examples of a single broader system that may have greater scope than any of the singular descriptions expressed. There may be many alterations made in the description without departing from the spirit and scope of the system.

What is claimed is:

1. A portable identity, document, transaction, data, and access management system for interoperable and reusable onboarding and client lifecycle management, comprising:
an identity management system employing at least machine or deep learning for streamlining functionality comprising biometrics analysis, optical character recognition for analyzing documents, leveraging identification systems and databases for training and verifying;
a document management system facilitating at least electronic file transfer, digital and biometric signatures, enabling at least the editing, sending, receiving, sharing, transferring, storing, tracking of documents;
a transaction management system utilizing at least machine or deep learning for activities comprising detecting known and unknown typologies, mitigating false positives, enabling at least the executing, clearing, settlement, monitoring, screening, recording, and reporting of transactions;
a communication system enabling at least two devices to have encrypted communication, facilitating secure transmission of identity, document, transactions;
an account management and monitoring system enabling at least algorithmic, machine and/or deep learning, logic, rules-based access, alerts, notifications;
at least one non-fungible smart contract or decentralized identifier for facilitating actions comprising synching, verifying, accessing, signing, sharing, downloading, executing, of identities, documents, transactions;
a wallet system for facilitating, authorizing, accessing, sorting, transferring, and tracking identities, documents, transactions, assets; and
a data storage system for storing, sharing, accessing, retrieving, updating, and synchronizing identity, document, and transaction information in centralized and/or decentralized capacities, data is routed, stored, and querying centralized and decentralized storage systems via at least a unique identifier.

2. The system of claim 1, wherein the communication system is utilizing video and/or messaging chat for at least two people to communicate and facilitate onboarding and client lifecycle management.

3. The system of claim 1, wherein the communication system utilizes near-frequency communication for contactless transmission of identities, documents, and transactions.

4. The system of claim 1, wherein the wallet system is synchronized with at least one non-fungible smart contract or decentralized identifier.

5. The system of claim 1, wherein the wallet system supports fiat, digital, and blockchain assets.

6. The system of claim 5, wherein the wallet system may be linked to at least one NFC embeddable and compatible virtual, digital, portable, and/or physical device.

7. A computer-implemented system for portable onboarding and client lifecycle management, comprising:
an identity management system employing at least machine or deep learning for streamlining identity verification functionality comprising biometrics analysis, optical character recognition for analyzing documents, leveraging identification systems and databases for training and verifying, wherein a document management system facilitates at least electronic file transfer, digital and biometric signatures, enabling at least the editing, sending, receiving, sharing, transferring, storing, tracking of documents, synchronized with a transaction management system for activities comprising executing, clearing, settlement, monitoring, screening, recording, and reporting of transactions;
a near-frequency communication system enabling at least two devices embedded/compatible with near-frequency technology to have single or multiplexed communication and data exchange via encrypted and unencrypted protocols, facilitating actions comprising the embedding and integrating NFC specifications for wireless short-range data exchange into NFC-compatible devices; and
a centralized and/or decentralized data storage system enabling actions comprising storing, sharing, accessing, pushing, retrieving, updating, identity, documents, and transactions, wherein at least one unique identifier synchronizes.

8. The system of claim 7, wherein the onboarding and client lifecycle management system enable at least identity management

9. The system of claim 8, wherein the onboarding and client lifecycle management system enables at least identity and transaction management

10. The system claim of 7, wherein the onboarding and client lifecycle system interacts with a wallet system, for actions comprising storing, sharing, accessing, pushing, retrieving, updating, identity, documents, transactions.

11. The system claim of 7, wherein at least one non-fungible smart contract or decentralized identifier is linked to at least one NFC-embedded device utilized by the system.

12. A computer-implemented method, comprising:
authenticating, the identity of at least one individual and/or business;
employing varying methods for ascertaining, qualifying, verifying identity, prior to fulfilling data requests between at least two systems, devices, applications, and/or networks;
requesting, receiving, sending, signing nonces between systems, devices, applications, and/or networks;
validating, unlocking credentials for accessing identity, document, and/or transactions synchronized to at least one individual and/or business;
querying, decentralized and/or centralized data storage systems, utilizing at least one unique identifier for identifying identity, document, and/or transactions;
retrieving, identity, document, and/or transaction data based on known or unknown onboarding criteria and requirements; and
transmitting, identity, document, and/or transaction data from centralized and/or decentralized storage, utilizing methods comprising API, webhook, QR code, NFC, enabling recycling and porting of identity, document, and transactions for onboarding and client lifecycle management.

13. The method of claim 12, wherein the decentralized storage siloes data of at least one individual and/or business into at least one data bucket.

14. The method of claim 13, wherein the decentralized storage is synchronized with at least one non-fungible token or decentralized identifier.
